(19) United States
(12) Patent Application Publication
(10) Pub. No.: US 2026/0046097 A1
(43) Pub. Date: Feb. 12, 2026

(54) UL CONTROL INFORMATION OMISSION HANDLING

(71) Applicant: Samsung Electronics Co., Ltd., Suwon-si (KR)

(72) Inventors: Gilwon Lee, Prosper, TX (US); Emad Nader Farag, Flanders, NJ (US); Eko Onggosanusi, Coppell, TX (US); Md. Saifur Rahman, Plano, TX (US)

(21) Appl. No.: 19/271,748

(22) Filed: Jul. 16, 2025

Related U.S. Application Data
(60) Provisional application No. 63/681,566, filed on Aug. 9, 2024.

(51) Int. Cl. H04L 5/00; H04W 72/21; H04W 72/232

(52) U.S. Cl. CPC H04L 5/0057; H04W 72/21; H04W 72/232

(57) ABSTRACT

Methods and apparatuses for uplink (UL) control information omission handling. A method performed by a user equipment (UE) includes receiving information about a channel state information (CSI) report and determining, based on the information a CSI part 1 and a CSI part 2 and a beta offset, an alpha value, or an indicator. The beta offset is a parameter to control a code rate for the CSI part 2. The alpha value is a scaling factor to limit a number of uplink (UL) resource elements (REs) for the CSI part 2. The indicator indicates information related to an additional UL resource allocation (UL RA) for the CSI part 2. The method further includes transmitting the CSI report including the CSI part 1 and the CSI part 2. The CSI part 1 includes at least one of the beta offset, the alpha value, and the indicator.

### CROSS-REFERENCE TO RELATED AND CLAIM OF PRIORITY

The present application claims priority under 35 U.S.C. § 119(e) to U.S. Provisional Patent Application No. 63/681,566 filed on Aug. 9, 2024, which are hereby incorporated by reference in their entirety.

### TECHNICAL FIELD

The present disclosure relates generally to wireless communication systems and, more specifically, the present disclosure relates to methods and apparatuses for uplink (UL) control information omission handling.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to UL control information omission handling.

In one embodiment, a user equipment (UE) is provided. The UE includes a transceiver configured to receive information about a channel state information (CSI) report and a processor operably coupled to the transceiver. The processor configured to determine, based on the information, a CSI part 1 and a CSI part 2 and a beta offset, an alpha value, or an indicator. The beta offset is a parameter to control a code rate for the CSI part 2. The alpha value is a scaling factor to limit a number of UL resource elements (REs) for the CSI part 2. The indicator indicates information related to an additional UL resource allocation (UL RA) for the CSI part 2. The transceiver is further configured to transmit the CSI report including the CSI part 1 and the CSI part 2. The CSI part 1 includes at least one of the beta offset, the alpha value, and the indicator.

In another embodiment, a base station (BS) is provided. The BS includes a processor and a transceiver operably coupled to the processor. The transceiver is configured to transmit information about a CSI report and receive the CSI report including a CSI part 1 and a CSI part 2. The CSI part 1 includes at least one of a beta offset, an alpha value, and an indicator. The beta offset is a parameter to control a code rate for the CSI part 2. The alpha value is a scaling factor to limit a number of UL REs for the CSI part 2. The indicator indicates information related to an additional UL RA for the CSI part 2.

In yet another embodiment, a method performed by a UE is provided. The method includes receiving information about a CSI report and determining, based on the information a CSI part 1 and a CSI part 2 and a beta offset, an alpha value, or an indicator. The beta offset is a parameter to control a code rate for the CSI part 2. The alpha value is a scaling factor to limit a number of UL REs for the CSI part 2. The indicator indicates information related to an additional UL RA for the CSI part 2. The method further includes transmitting the CSI report including the CSI part 1 and the CSI part 2. The CSI part 1 includes at least one of the beta offset, the alpha value, and the indicator.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates example physical uplink control channel (PUCCH) resource sets according to embodiments of the present disclosure;

FIGS. 6A and 6B illustrate an example downlink (DL) medium access control (MAC) protocol data unit (PDU) and UL MAC PDU according to embodiments of the present disclosure;

FIGS. 7A, 7B, 7C, and 7D illustrate timelines for mapping UL control information according to embodiments of the present disclosure;

FIGS. 8A, 8B, and 8C illustrate example UL control information according to embodiments of the present disclosure;

FIGS. 9A, 9B, and 9C illustrate example UL control information according to embodiments of the present disclosure;

FIGS. 10A, 10B, and 10C illustrate example UL control information according to embodiments of the present disclosure;

FIG. 11 illustrates an example UL control information according to embodiments of the present disclosure;

FIGS. 12A, 12B, and 12C illustrate an example UL transmission according to embodiments of the present disclosure;

FIGS. 13A, 13B, and 13C illustrate an example UL transmission according to embodiments of the present disclosure;

FIGS. 14A, 14B, and 14C illustrate an example UL transmission according to embodiments of the present disclosure;

FIG. 15 illustrates an example UL transmission according to embodiments of the present disclosure;

FIGS. 16A, 16B, and 16C illustrate an example UL transmission according to embodiments of the present disclosure;

FIG. 17 illustrates an example UL transmission according to embodiments of the present disclosure;

FIG. 18 illustrates example UL transmission resources according to embodiments of the present disclosure;

FIG. 19 illustrates example UL transmission resources according to embodiments of the present disclosure;

FIG. 20 illustrates example UL transmission resources according to embodiments of the present disclosure;

FIG. 21 illustrates an example of CSI according to embodiments of the present disclosure; and

FIG. 22 illustrates an example method performed by a UE in a wireless communication system according to embodiments of the present disclosure.

### DETAILED DESCRIPTION

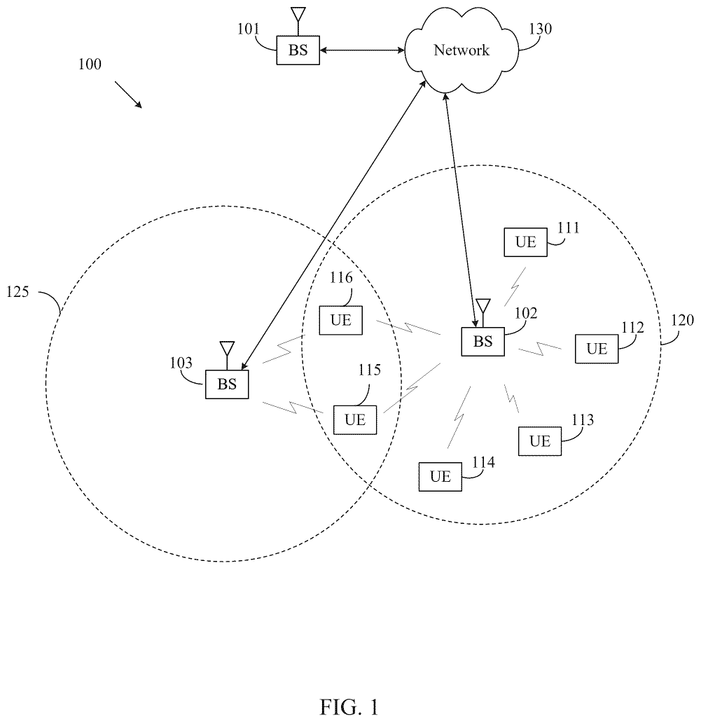

FIGS. 1-22, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1]3GPP TS 38.211 v18.3.0, “NR; Physical channels and modulation;” [REF 2]3GPP TS 38.212 v18.3.0, “NR; Multiplexing and Channel coding;” [REF 3]3GPP TS 38.213 v18.3.0, “NR; Physical Layer Procedures for Control;” [REF 4]3GPP TS 38.214 v18.3.0, “NR; Physical Layer Procedures for Data;” [REF 5]3GPP TS 38.321 v18.2.0, “NR; Medium Access Control (MAC) protocol specification;” and [REF 6]3GPP TS 38.331 v18.2.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for performing UL control information omission handling. In certain embodiments, one or more of the BSs 101-103 include circuitry, programing, or a combination thereof to support UL control information omission handling.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

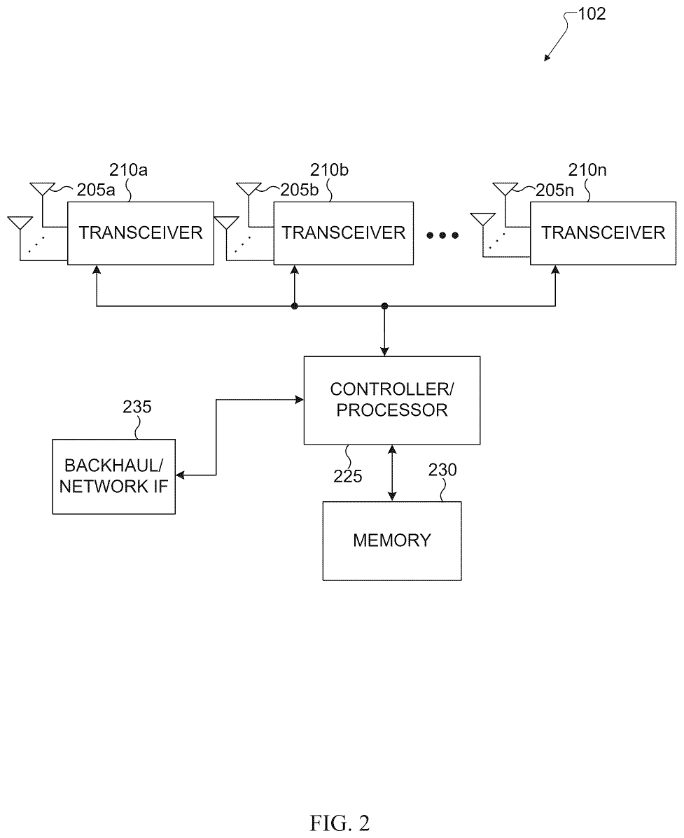

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by ULEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting UL control information omission handling. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

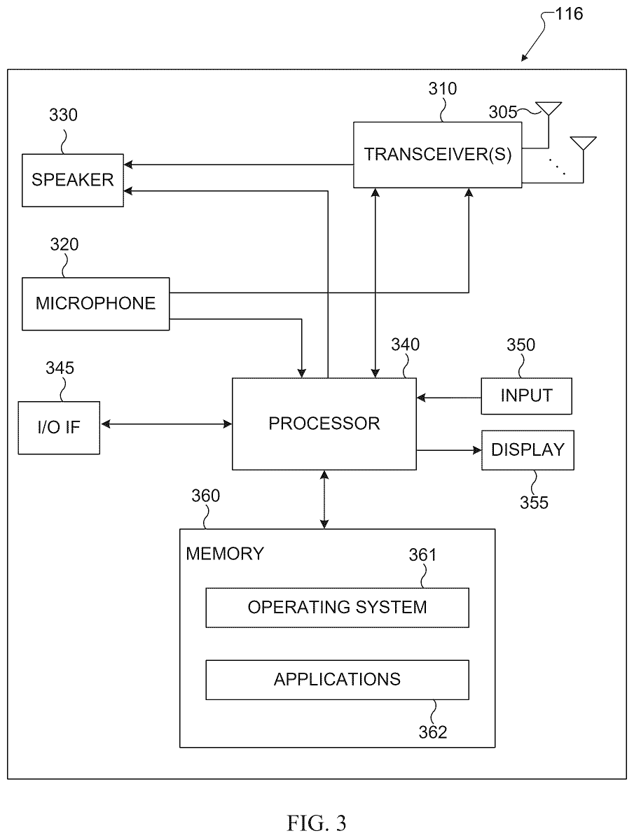

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for UL control information omission handling as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

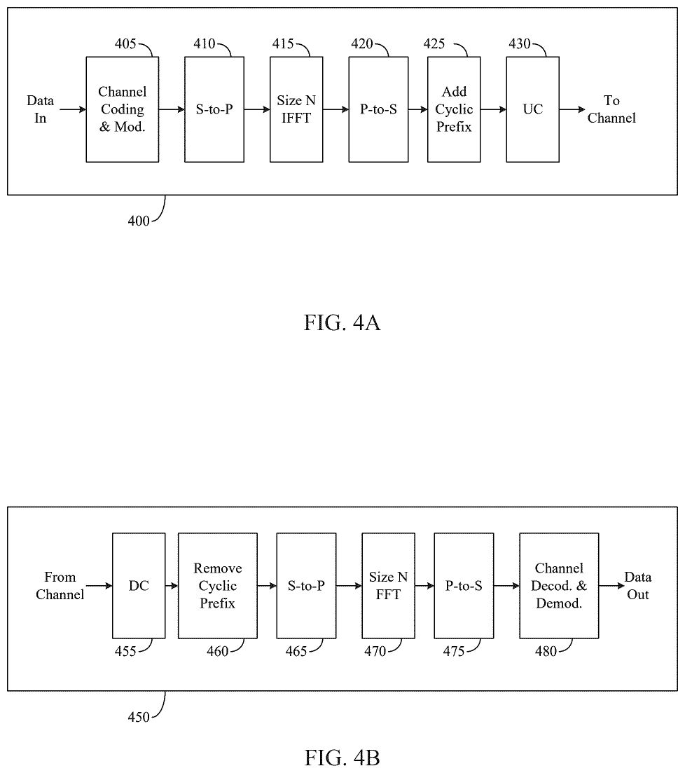

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 is configured to utilize UL control information omission handling as described in embodiments of the present disclosure. In some embodiments, the receive path 450 is configured to manage UL control information omission handling as described in embodiments of the present disclosure.

As illustrated in FIG. 4A, the transmit path 400 includes a channel coding and modulation block 205, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 KHz and include 12 SCs with inter-SC spacing of 15 KHz. A slot can be either full DL slot, or full UL slot, or hybrid slot similar to a special subframe in time division duplex (TDD) systems (see also REF 1).

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a transmission configuration indication state (TCI state) of a control resource set (CORESET) where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more of multiple types of RS including channel state information RS (CSI-RS) and demodulation RS (DMRS)—see also REF 1. A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used (see also REF 3). A CSI process includes NZP CSI-RS and CSI-IM resources. A UE can determine CSI-RS transmission parameters through DL control signaling or higher layer signaling, such as radio resource control (RRC) signaling from a gNB (see also REF 5). Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access (see also REF 1). A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in its buffer, link recovery request (LRR) for beam failure recovery, and CSI reports enabling a gNB to select appropriate parameters for PDSCH or PDCCH transmissions to a UE. A CSI report can include a single part, or for two parts (e.g., part 1 CSI and part 2 CSI). HARQ-ACK information can be configured to be with a smaller granularity than per TB and can be per data code block (CB) or per group of data CBs where a data TB includes a number of data CBs. A CSI report from a UE can include a channel quality indicator (CQI) informing a gNB of a largest modulation and coding scheme (MCS) for the UE to detect a data TB with a predetermined block error rate (BLER), such as a 10% BLER (see also REF 3), of a precoding matrix indicator (PMI) informing a gNB how to combine signals from multiple transmitter antennas in accordance with a multiple input multiple output (MIMO) transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random access channel (physical random access channel (PRACH), see also REF 3 and REF 4).

The UL control information UCI, can be multiplexed on physical uplink control channel (PUCCH). There are 5 PUCCH formats, depending of the length of the PUCCH format (number of symbols of the PUCCH format), and the UCI payload size as illustrated in Table 1.

TABLE 1

| | UCI payload 1 or 2 bit | UCI payload more than 2 bits |
|---|---|---|
| PUCCH length 1 or 2 symbols | PUCCH Format 0 | PUCCH Format 2 |
| PUCCH length 4 to 14 symbols | PUCCH Format 1 | PUCCH Format 3 or 4 |

PUCCH Format 4, has 1 physical resource block (PRB), and multiplex 2 or 4 users on the same physical resource using different spreading codes.

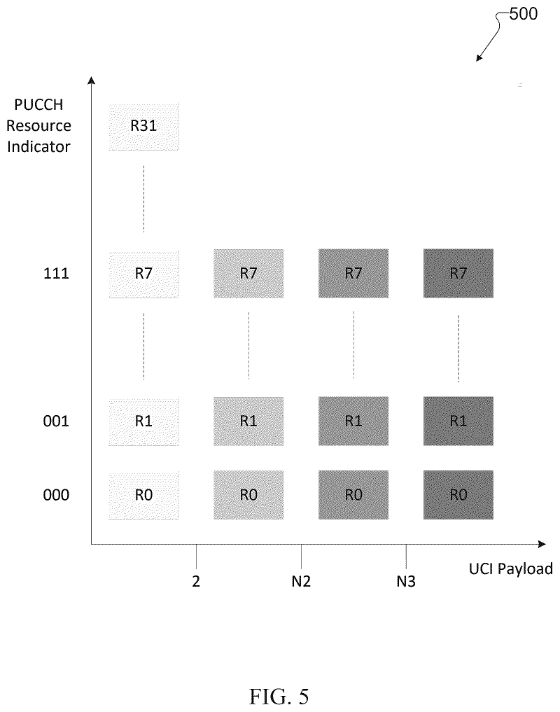

FIG. 5 illustrates example PUCCH resource sets 500 according to embodiments of the present disclosure. For example, PUCCH resource sets 500 can be utilized by any of the UEs 111-116 of FIG. 1. This example is for illustration only and other embodiments can be used without departing from the scope of the present disclosure.

The network (e.g., the network 130) can configure 4 PUCCH resource sets, where each PUCCH resource set is associated with a UCI payload size. The first PUCCH resource set is used for payload size 2 bits and can have up to 32 PUCCH resources. The second PUCCH resource set is used for 2<payload size N₂. The third PUCCH resource set is used for N₂<payload size N₃. The fourth PUCCH resource set is used for payload size >N₃. Each of the second, third and fourth PUCCH resource sets can have 8 PUCCH resources. This is illustrated in FIG. 5. A PUCCH resource is determined by PUCCH resource index (PRI), channel control element (CCE) index (when payload size is 1 or 2 bits) and payload size.

When the CSI report is a single part, the UE multiplexes, the HARQ-ACK information, the scheduling request and the CSI information into a single UCI message, this message is then encoded, rate-matched, scrambled, modulated and mapped to the resource elements of PUCCH not used for DMRS. When the CSI report has two parts, a first part CSI and a second part CSI. The first part UCI information includes HARQ-ACK information, scheduling request and first part CSI. The second part UCI information includes second part CSI. The mapping of UCI information to PUCCH resource element is performed as follows:
First, the first part UCI information is mapped to PUCCH OFDM symbols that are closets to DMRS symbols.
Next, the second part UCI information is mapped to the remaining PUCCH resource elements.

When a PUCCH transmission overlaps with a PUSCH transmission, the UCI information is multiplexed onto the PUSCH channel:
First HARQ-ACK information is multiplexed into PUSCH starting from the first OFDM symbol after the first DMRS symbol in each frequency hop.
Next, the first part CSI is multiplexed into PUSCH starting from the first OFDM symbol of each frequency hop.
Next, the second part CSI is multiplexed into PUSCH after the first part CSI.
Finally, the transport block from higher layers is multiplexed into the remaining PUSCH resource elements not used for other purposes.

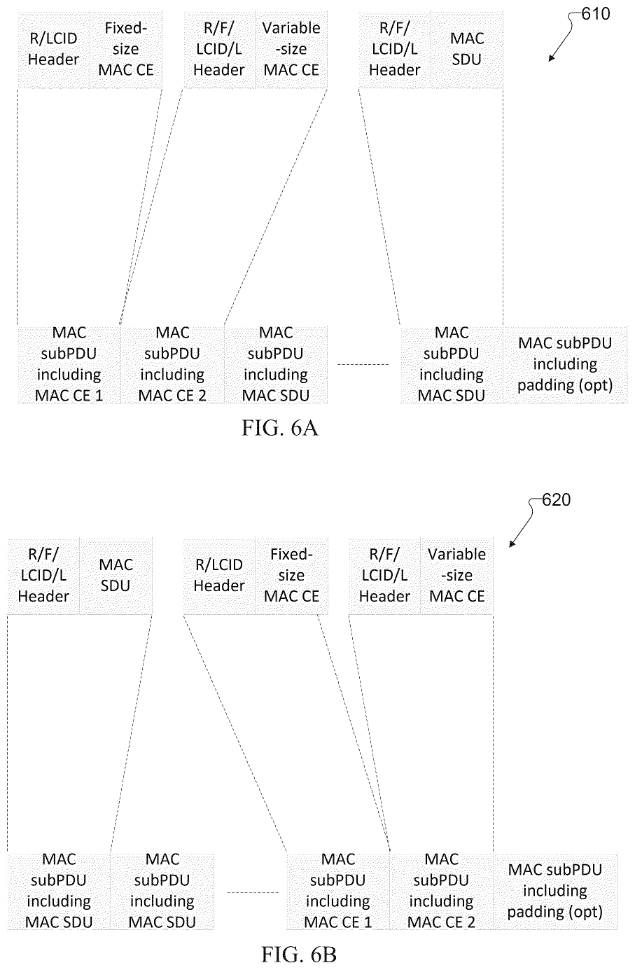

FIGS. 6A and 6B illustrate an example DL MAC PDU 610 and UL MAC PDU 620, respectively, according to embodiments of the present disclosure. For example, a DL MAC PDU 610 can be implemented in the BS 102 of FIG. 2 while UL MAC PDU 620 can be implemented in the UE 116 of FIG. 3. This example is for illustration only and other embodiments can be used without departing from the scope of the present disclosure.

A transport block from higher layers includes a MAC PDU, which can include one or more of
Fixed-size MAC CE(s).
Variable size MAC CE(s).
MAC SDU(s)
Optional padding.

A DL MAC PDU (e.g., transport block) is illustrated in FIG. 6A. An UL MAC PDU (e.g., transport block) L is illustrated in FIG. 6B.

This disclosure provides various mapping and multiplexing options of UL control information on to UL physical channels to simplify UL control information transmission.

As mentioned herein, in NR, there are different PUCCH formats for transmission of UL control information, in addition to transmitting UL control information in PUSCH, when a PUCCH channel overlaps in time with a PUSCH channel. This increases the complexity of the multiplexing and transmitting UL control information. To address this issue, embodiments of the present disclosure recognize that using PUCCH is needed when the UCI payload is small. Embodiments of the present disclosure further recognize that, for larger payloads, UCI can be mapped to and multiplexed on PUSCH channel. Different types of UL control channel information can have different characteristics, e.g., different error protection requirements, or different latency requirements. In this disclosure the container used for UL control information is evaluated. For example, the container can be a MAC CE-like message, or UCU-like message, each can have its own transport characterises. In some instances, different types of control information and other UL data can be multiplexed together, for example, the control information elements and the UL data have similar transport characteristics (latency, BLER, etc.). In other instances, the transport characteristics of the control information elements and UL data can be different, hence different containers can be used. In this disclosure a flexible design is provided to cater for different scenarios.

The present disclosure relates to a 5G/NR and/or 6G communication system.

This disclosure provides aspects related mapping and multiplexing of UL control information onto UL physical channels. This disclosure includes the following:
Type of physical UL channel used for UL control information can depend UCI payload size, and on whether UCI is being multiplexed with other UL traffic.
When control information elements and/or other UL data are multiplexed onto the same physical channel with different transport characteristics, different containers can be used that can be encoded with different code rates and that can be mapped differently on the physical channel.
UCI omission handling for PUSCH

In the following, both frequency division duplexing (FDD) and time division duplexing (TDD) are regarded as a duplex method for DL and UL signaling.

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure provides several components that can be used in conjunction or in combination with one another, or can operate as standalone schemes.

In this disclosure, RRC signaling (e.g., configuration by RRC signaling) includes (1) common signaling, e.g., this can be system information block (SIB)-based RRC signaling (e.g., SIB1 or other SIB) or (2) RRC dedicated signaling that is sent to a specific UE or (3) UE-group RRC signaling.

In this disclosure MAC CE signaling can be UE-specific e.g., to one UE and can be UE common (e.g., to a group of UEs). MAC CE signaling can be DL MAC CE signaling or UL MAC CE signaling.

In this disclosure L1 control signaling includes: (1) DL control information (e.g., DCI on PDCCH or DL control information on PDSCH) and/or (2) UL control information (e.g., UCI on PUCCH or PUSCH). L1 control signaling be UE-specific e.g., to one UE and can be UE common (e.g., to a group of UEs).

In this disclosure a list with N elements can be denoted as L(i), where i can take N values, and L(i) can correspond to the element associated with index i. In one example, i can take N arbitrary values. In one example, i=0, 1, . . . , N−1. In one example, i=1, 2, . . . , N. In one example, i is an identity of an element in the list.

In the present disclosure, the term “activation” describes an operation wherein a UE receives and decodes a signal from the network (or gNB) that signifies a starting point in time. The starting point can be a present or a future slot/subframe or symbol and the exact location is either implicitly or explicitly indicated, or is otherwise defined in the system operation or is configured by higher layers. Upon successfully decoding the signal, the UE responds according to an indication provided by the signal. The term “deactivation” describes an operation wherein a UE receives and decodes a signal from the network (or gNB) that signifies a stopping point in time. The stopping point can be a present or a future slot/subframe or symbol and the exact location is either implicitly or explicitly indicated, or is otherwise defined in the system operation or is configured by higher layers. Upon successfully decoding the signal, the UE responds according to an indication provided by the signal.

Terminology such as UCI, MAC CE, PUCCH, PUSCH, transport block and other terms are used for illustrative purposes and is therefore not normative. Other terms that refer to same functions can also be used.

In this disclosure, UL control information can include the following UL control information types:
HARQ-ACK for DL transport blocks.
Scheduling request (SR).
Channel state information (CSI). In one example, CSI can be a single part CSI. In another example, CSI can be a two-part CSI, e.g., a first part CSI and a second part CSI.
Link recovery request (LRR), this can be similar to SR.
Beam indication/report (introduced in 3GPP Rel-19).
Transport format indication information, e.g., indicating modulation coding scheme, and/or transport block size and/or resource allocation and/or HARQ related parameters and/or MIMO related parameters of data conveyed in the UL physical channel.

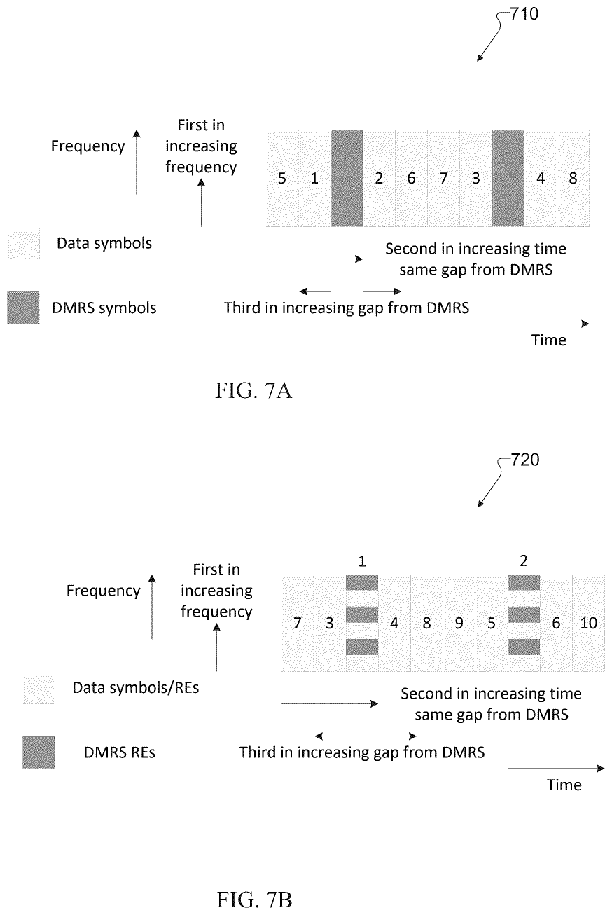

FIGS. 7A, 7B, 7C, and 7D illustrate timelines 710, 720, 730, and 740, respectively, for mapping UL control information according to embodiments of the present disclosure. For example, timelines 710, 720, 730, and 740, respectively, can be followed by any of the UEs 111-116 of FIG. 1, such as the UE 111. This example is for illustration only and other embodiments can be used without departing from the scope of the present disclosure.

In one example, the information corresponding to each of the UL control information types mentioned herein can be transmitted independently, e.g., the information for each UL control information type is separately encoded and multiplexed or mapped onto the physical UL channel.

In another example, information corresponding to each of the UL control information types mentioned herein can be first multiplexed, and then jointly encoded, rate-matched, scrambled and/or modulated and mapped to resource elements of the corresponding physical UL channel. For example, in NR, when CSI has one part, the HARQ-ACK, SR and CSI information are multiplexed, and jointly pass through the encoding and transmission stages and are transmitted on PUCCH.

In another example, the UL control information types are divided into groups, where information corresponding to each group of UL control information types can be first multiplexed, and then jointly encoded, rate-matched, scrambled and/or modulated and mapped to resource elements of the corresponding physical UL channel. For example, in NR, when CSI has two parts, the HARQ-ACK, SR and CSI information are multiplexed to give first part of UCI, and jointly pass through the encoding and transmission stages and are transmitted on PUCCH. The second part CSI can be separately encoded and mapped to the remaining PUCCH resources. UL control information types that are multiplexed together and jointly encoded and transmitted can have similar transport characteristics. The first part UCI is mapped closer to the DMRS symbols, and then the second part UCI is mapped to DMRS symbols that are further out. Mapping order can be also as follows, as illustrated in FIG. 7A and FIG. 7B:
First in increasing order of frequency resources within each OFDM symbol.
Next in increasing symbol number for symbols that have the same time gap to closest DMRS symbol in the same frequency hop.
Finally, in increasing time gap from closest DMRS in the same frequency hop.
Mapping performed first for UCI part one symbols. Then for UCI part two symbols.

In FIG. 7A, as an example, REs of a symbol are allocated to DMRS, or there are no REs available for data, the first symbol selected for mapping is the first data symbol before the first DMRS symbol, starting with the first part UCI, first part UCI modulation symbols are mapped in increasing order of frequency, then first data symbol after the first DMRS symbol, then the first data symbol before the second DMRS symbol, then the first data symbol after the second DMRS symbol, then the second data symbol before the first DMRS symbol and so on. After the modulation symbols of the first part UCI are mapped, the modulation symbols of the second part UCI are mapped continuing in the same order.

In FIG. 7B, as an example, there are resource elements (REs) in the DMRS symbols available for data, the first symbol selected for mapping is the first DMRS symbol, starting with the first part UCI, first part UCI modulation symbols are mapped in increasing order of frequency, then second DMRS symbol, then first data symbol before the first DMRS symbol, then first data symbol after the first DMRS symbol, then the first data symbol before the second DMRS symbol, then the first symbol data after the second DMRS symbol, then the second data symbol before the first DMRS symbol and so on. After the modulation symbols of the first part UCI are mapped, the modulation symbols of the second part UCI are mapped continuing in the same order.

While, the example given is for two parts, there can be multiple UL control information parts, for example a first part can include HARQ-ACK and SR, a second part can include part 1 CSI, and a third part can include part 2 CSI. In one example, the first UCI part is mapped to symbols that closest to DMRS, followed by second part UCI that the mapped following first UCI part to symbols that are closest to DMRS, followed by third part UCI to remaining symbols. Mapping order can be also as follows, as illustrated in FIG. 7C and FIG. 7D:
First in increasing order of frequency resources within each OFDM symbol.
Next in increasing symbol number for symbols that have the same time gap to closest DMRS symbol in the same frequency hop.
Finally, in increasing time gap from closest DMRS in the same frequency hop.
Mapping performed first for UCI part one symbols. Then for UCI part two symbols. Then for UCI part three symbols.

In an alternative to the mapping order of FIG. 7A, and FIG. 7B, the UCU modulation symbols are mapped to OFDM symbols with REs available data transmission starting from the first OFDM symbol of the allocation as illustrated in FIG. 7C and FIG. 7D. Mapping order can be:
First in increasing order of frequency resources within each OFDM symbol.
Next in increasing symbol number.

In one example, the container for UL control information can be UCI-like message. One part UCI, or two part UCI or multiple part UCI, contents of each part as previously described. In one example, the UCI messages can be multiplexed together, and with other UCI messages such as power headroom (PHR) UCI message and buffer status report (BSR) UCI message, hence have same transport characteristic with no distinction. In another example, each UCI message or each group of UCI messages is separately encoded and hence can have different transport characteristics.

In one example, the container for UL control information can be MAC CE message. One MAC CE corresponding to one part. Two MAC CEs corresponding to two parts respectively. Multiple MAC CEs corresponding to multiple parts respectively. Contents of each part can be as previously described. In one example, the MAC CEs can be multiplexed together, and with other MAC CEs such as power headroom (PHR) MAC CE and buffer status report (BSR) MAC CE, hence have same transport characteristic with no distinction. In another example, each MAC CE or each group of MAC CEs is separately encoded and hence can have different transport characteristics.

In one example, the container for UL control information can be RRC-like message. One RRC message corresponding to one part. Two RRC messages corresponding to two parts respectively. Multiple RRC messages corresponding to multiple parts respectively. Contents of each part can be as previously described. In one example, the RRC messages can be multiplexed together, and with other RRC messages such as power headroom (PHR) RRC message and buffer status report (BSR) RRC message, hence have same transport characteristic with no distinction. In another example, each RRC message or each group of RRC messages is separately encoded and hence can have different transport characteristics.

In one example, the physical channel to use can depend on the size of the UCI payload and/or on whether or not UL data is transmitted with UCI.

In one example, if the size of UL control information is less than or equal to N₁ (e.g., N₁=2) PUCCH format 0 or PUCCH Format 1 is used.

In one example, if size of UL control information is greater than N₁ (e.g., N₁=2) and less than or equal to N₂ PUCCH Format 4 in used.
In one example, PUCCH format 4 has one PRB in frequency domain.
In one example, PUCCH format 4 can have 4 to 14 symbols.
In one example PUCCH format 4 can have 1 or 2 or 3 symbols.
In one example if N₁=N₂ and there is no PUCCH format 4

In one example, if the size of UL control information is greater than N₂ use PUSCH.

In one example, if physical channel to use for UL control information overlaps with a PUSCH (e.g., the PUSCH is carrying higher layer data, the UL control information is multiplexed onto the PUSCH.

In one example, SR can be multiplexed on a PUCCH Format.

In one example, SR can be multiplexed on PUCCH or on PUSCH, if PUSCH has no UL-SCH.

In one example, if SR occasion overlaps a PUSCH transmission, a buffer status report (BSR) can be transmitted in the PUSCH.

In one example, if the HARQ-ACK payload is less than or equal to N₂ bits, HARQ-ACK information is transmitted on PUCCH.

In one example, if the HARQ-ACK payload is more than N₂ bits, HARQ-ACK information is transmitted on PUSCH.

In one example, if the HARQ-ACK+SR payload is less than or equal to N₂ bits, HARQ-ACK and SR information are transmitted on PUCCH.

In one example, if the HARQ-ACK+SR payload is more than N₂ bits, HARQ-ACK and SR information are transmitted on PUSCH.

In one example, if the HARQ-ACK+SR payload is more than N₂ bits, HARQ-ACK and buffer status report are transmitted on PUSCH.

In one example, there can be more than one bit for SR in order to also indicate the logical channel (LCH) but if only 1-2 HARQ-ACK bits (PF0/PF1 used), the SR is identified by the SR resource used for PUCCH transmission.

In one example, if the CSI payload is less than or equal to N₂ bits, CSI information is transmitted on PUCCH.

In one example, if the CSI payload is more than N₂ bits, CSI information is transmitted on PUSCH.

In one example, regardless of CSI payload size, CSI can be on PUSCH. That can simplify resolution of PUCCH overlapping and multiplexing rules.

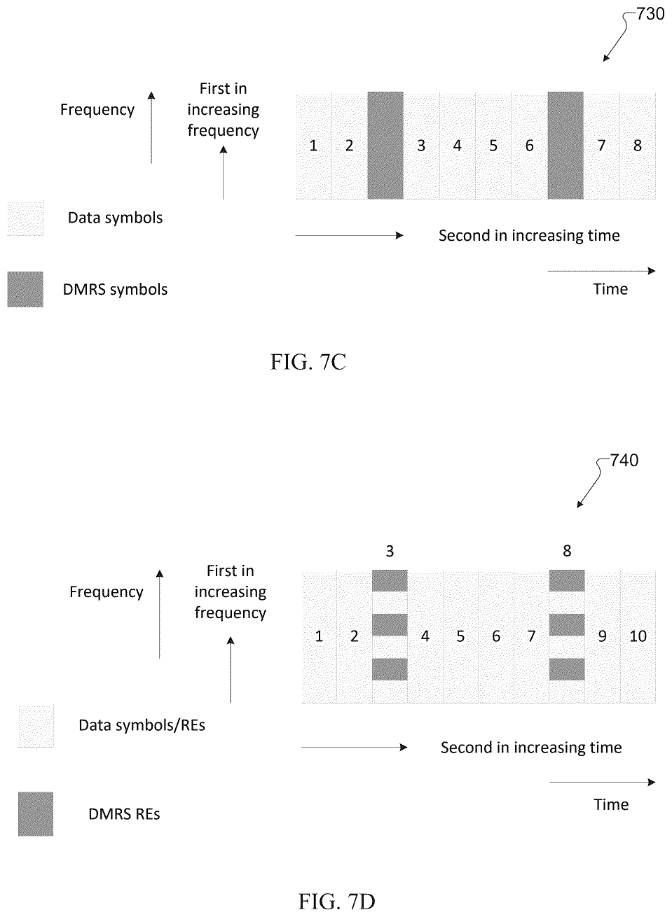

FIGS. 8A, 8B, and 8C illustrate example UL control information 810, 820, and 830, respectively, according to embodiments of the present disclosure. For example, UL control information 810, 820, and 830, respectively, can be generated by any of the UEs 111-116 of FIG. 1, such as the UE 112. This example is for illustration only and other embodiments can be used without departing from the scope of the present disclosure.

In one example in FIG. 8, UL control information include HARQ-ACK information. The HARQ-ACK information is mapped to UCI block. If the HARQ-ACK information is less than or equal to N₁ bits (e.g., N₁=2), PUCCH format 0 or PUCCH format 1 is used to transmit the HARQ-ACK information (FIG. 8A). If the HARQ-ACK information is less than or equal to N₂ and more than N₁, PUCCH format 4 is used to transmit the HARQ-ACK information. If the HARQ-ACK information is more than N₂, PUSCH is used to transmit the HARQ-ACK information.

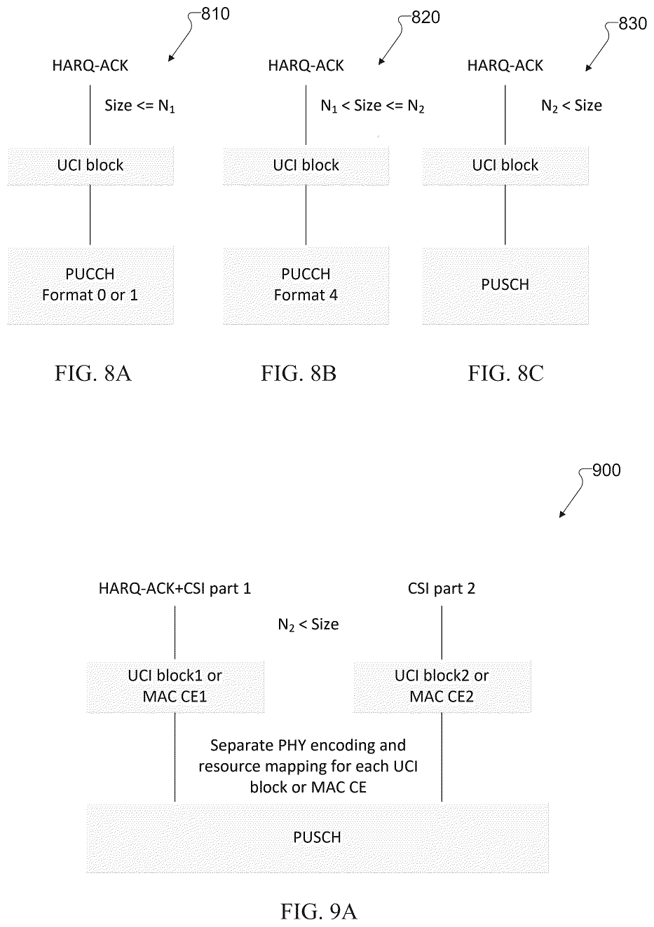

FIGS. 9A, 9B, and 9C illustrate example UL control information 900, 920, and 930, respectively, according to embodiments of the present disclosure. For example, UL control information 900, 920, and 930, respectively, can be generated by any of the UEs 111-116 of FIG. 1, such as the UE 113. This example is for illustration only and other embodiments can be used without departing from the scope of the present disclosure.

In one example in FIG. 9A, UL control information can include HARQ-ACK information and CSI information. CSI information can include part 1 CSI and part 2 CSI. In one example, there are two UCI blocks or two MAC CE blocks or one UCI block and one MAC CE block, wherein the first UCI block or MAC CE is for HARQ-ACK+part 1 CSI and the second UCI block or MAC CE is for part 2 CSI. Each UCI block or MAC CE can be separately encoded and mapped to resource elements of PUSCH in the physical layer (hence different code rates).

In one example in FIG. 9B, UL control information can include HARQ-ACK information and CSI information. CSI information can include part 1 CSI and part 2 CSI. In one example, there are three UCI blocks or three MAC CE blocks or a combination of three UCI blocks and MAC CE blocks, wherein the first UCI block or MAC CE is for HARQ-ACK and the second UCI block or MAC CE is for part 1 CSI and the third UCI block or MAC CE is for part 1 CSI. Each UCI block or MAC CE can be separately encoded and mapped to resource elements of PUSCH in the physical layer (hence different code rates).

In one example in FIG. 9C, UL control information can include HARQ-ACK information and CSI information. In one example CSI information can be a single part. In one example, CSI information can include part 1 CSI and part 2 CSI. In one example, there are two UCI blocks or two MAC CE blocks or one UCI block and one MAC CE block, wherein the first UCI block or MAC CE is for HARQ-ACK and the second UCI block or MAC CE is for CSI (single part or two part CSI (part1 CSI+part 2 CSI)). Each UCI block or MAC CE can be separately encoded and mapped to resource elements of PUSCH in the physical layer (hence different code rates).

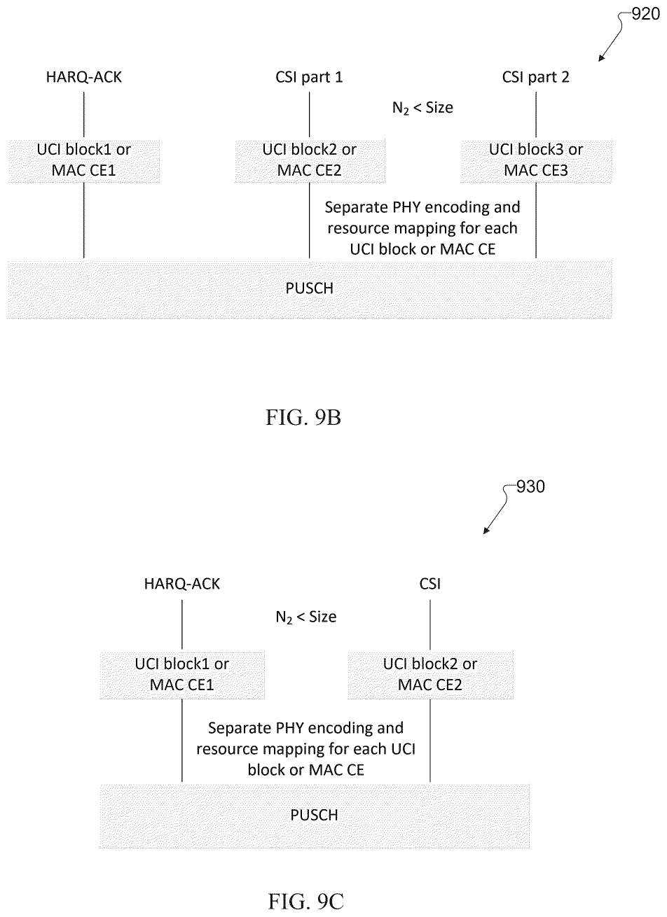

FIGS. 10A, 10B, and 10C illustrate example UL control information 1010, 1020, and 1030, respectively, according to embodiments of the present disclosure. For example, UL control information 1010, 1020, and 1030, respectively, can be generated by any of the UEs 111-116 of FIG. 1, such as the UE 114. This example is for illustration only and other embodiments can be used without departing from the scope of the present disclosure.

In one example in FIG. 10A, UL control information can include HARQ-ACK information and CSI information. CSI information can include part 1 CSI and part 2 CSI. In one example, there are two UCI blocks or two MAC CE blocks or one UCI block and one MAC CE block, wherein the first UCI block or MAC CE is for HARQ-ACK+part 1 CSI and the second UCI block or MAC CE is for part 2 CSI. The UCI block(s) or MAC CE(s) are multiplexed together and can be jointly encoded and mapped to resource elements of PUSCH in the physical layer (hence same code rate).

In one example in FIG. 10B, UL control information can include HARQ-ACK information and CSI information. CSI information can include part 1 CSI and part 2 CSI. In one example, there are three UCI blocks or two MAC CE blocks or a combination of three UCI blocks and MAC CE blocks, wherein the first UCI block or MAC CE is for HARQ-ACK and the second UCI block or MAC CE is for part 1 CSI and the third UCI block or MAC CE is for part 2 CSI. The UCI block(s) or MAC CE(s) are multiplexed together and can be jointly encoded and mapped to resource elements of PUSCH in the physical layer (hence same code rate).

In one example in FIG. 10C, UL control information can include HARQ-ACK information and CSI information. In one example CSI information can be a single part. In one example, CSI information can include part 1 CSI and part 2 CSI. In one example, there are two UCI blocks or two MAC CE blocks or one UCI block and one MAC CE block, wherein the first UCI block or MAC CE is for HARQ-ACK and the second UCI block or MAC CE is for CSI (single part or two part CSI (part1 CSI+part 2 CSI)). The UCI block(s) or MAC CE(s) are multiplexed together and can be jointly encoded and mapped to resource elements of PUSCH in the physical layer (hence same code rate).

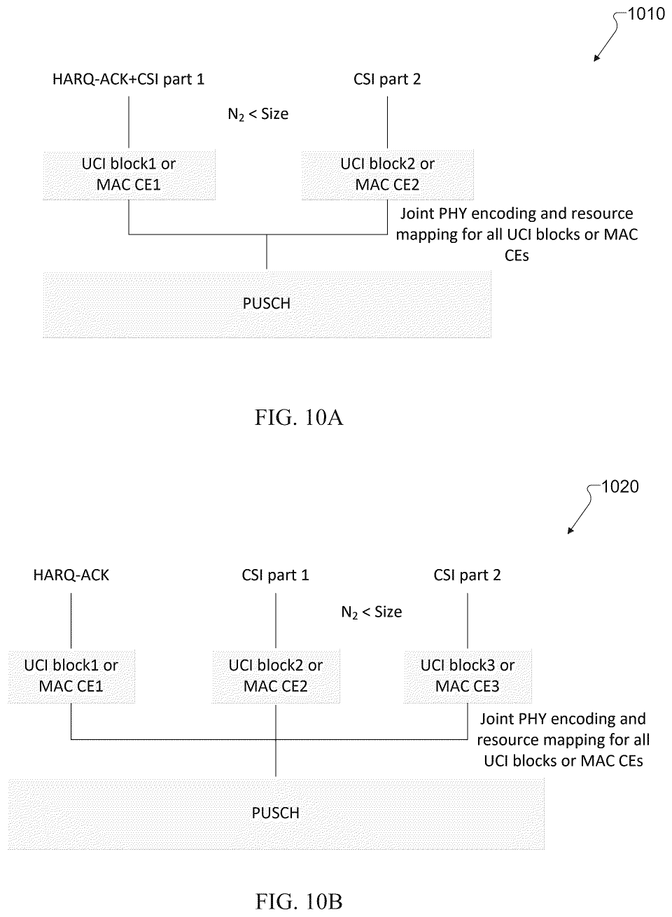

FIG. 11 illustrates an example UL control information 1100 according to embodiments of the present disclosure. For example, UL control information 1100 can be generated by any of the UEs 111-116 of FIG. 1, such as the UE 115. This example is for illustration only and other embodiments can be used without departing from the scope of the present disclosure.

In one example in FIG. 11, UL control information can include HARQ-ACK information and CSI information. In one example, CSI information can include part 1 CSI and part 2 CSI. In one example, CSI information can be a single part. In one example, there is one UCI block or one MAC CE block, wherein the UCI block or MAC CE is for HARQ-ACK+part 1 CSI+part 2 CSI or HARQ-ACK+CSI. The UCI block or MAC CE is encoded and mapped to resource elements of PUSCH in the physical layer (hence same code rate).

In the following examples, an UL transmission can include (1) UL control information which can include HARQ-ACK information and/or CSI information (2) other MAC CEs (e.g., BSR and PHR) and UL data.

In a variant of the following examples, HARQ-ACK is in a first CB, CSI is in a second CB, each CB can have its own code rate, UL SCH with other MAC CEs is in another one or more CBs. In one example, CSI can have a variable size, but the CB can be dimensioned for a given maximum size and the UE (e.g., the UE 116) can drop CSI or part of it if exceeded (this can be similar, not same, to PUCCH with max number of RBs).

In a variant of the following examples, HARQ-ACK is in a first CB, CSI part 1 is in second CB, CSI part 2 is in a third CB, each CB can have its own code rate, UL SCH with other MAC CEs is in another one or more CBs. In one example, CSI part 2 can have a variable size, but the CB can be dimensioned for a given maximum size and the UE can drop CSI part 2 or part of it if exceeded (this can be similar, not same, to PUCCH with max number of RBs).

In a variant of the following examples, HARQ-ACK+CSI part 1 is in one CB, and CSI part 2 is in a second CB, each CB can have its own code rate, UL SCH with other MAC CEs is in another one or more CBs. In one example, CSI part 2 can have a variable size, but the CB can be dimensioned for a given maximum size and the UE can drop CSI part 2 or part of it if exceeded (this can be similar, not same, to PUCCH with max number of RBs).

In a variant of the following examples, HARQ-ACK+CSI part 1/part 2 is in one CB, can have its own code rate, UL SCH with other MAC CEs is in another one or more CBs. In one example, CSI part 2 can have a variable size, but the CB can be dimensioned for a given maximum size and the UE can drop CSI part 2 or part of it if exceeded (this can be similar, not same, to PUCCH with max number of RBs).

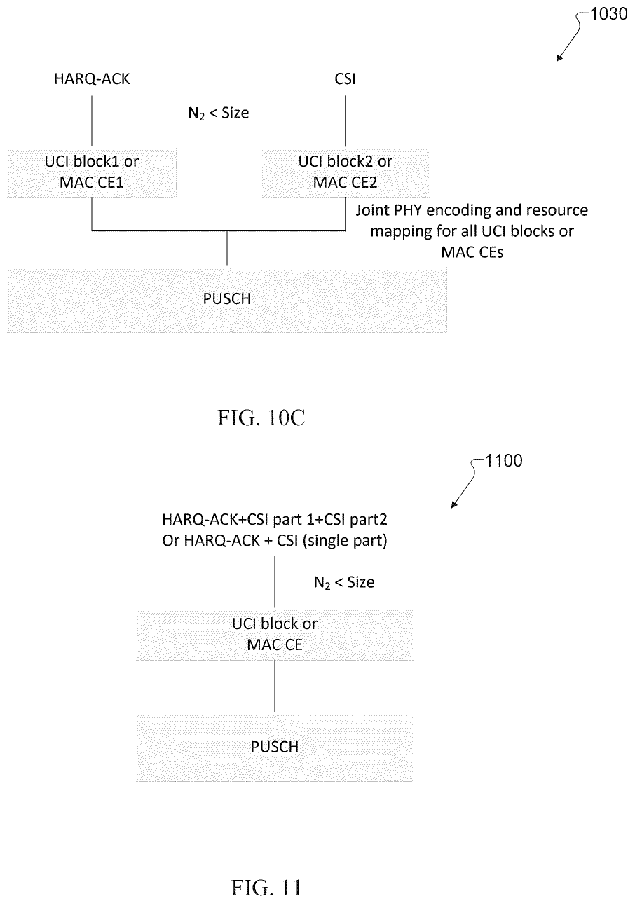

FIGS. 12A, 12B, and 12C illustrate an example UL transmission 1210, 1220, and 1230, respectively, according to embodiments of the present disclosure. For example, UL transmission 1210, 1220, and 1230, respectively, can be transmitted by any of the UEs 111-116 of FIG. 1, such as the UE 116. This example is for illustration only and other embodiments can be used without departing from the scope of the present disclosure.

In one example in FIG. 12A, UL transmission can include, (1) UL control information, wherein UL control information can include HARQ-ACK information and CSI information, and (2) UL-SCH with other MAC CEs e.g., BSR and/or PHR. CSI information can include part 1 CSI and part 2 CSI. In one example, there are two UCI blocks or two MAC CE blocks or one UCI block and one MAC CE block, wherein the first UCI block or MAC CE is for HARQ-ACK+part 1 CSI and the second UCI block or MAC CE is for part 2 CSI, in addition to a transport block for the UL-SCH with other MAC CEs. Each UCI block or MAC CE and transport block can be separately encoded and mapped to resource elements of PUSCH in the physical layer (hence different code rates).

In one example in FIG. 12B, UL transmission can include, (1) UL control information, wherein UL control information can include HARQ-ACK information and CSI information, and (2) UL-SCH with other MAC CEs e.g., BSR and/or PHR. CSI information can include part 1 CSI and part 2 CSI. In one example, there are three UCI blocks or three MAC CE blocks or a combination of three UCI blocks and MAC CE blocks, wherein the first UCI block or MAC CE is for HARQ-ACK and the second UCI block or MAC CE is for part 1 CSI and the third UCI block or MAC CE is for part 2 CSI, in addition to a transport block for the UL-SCH with other MAC CEs. Each UCI block or MAC CE and transport block can be separately encoded and mapped to resource elements of PUSCH in the physical layer (hence different code rates).

In one example in FIG. 12C, UL transmission can include, (1) UL control information, wherein UL control information can include HARQ-ACK information and CSI information, and (2) UL-SCH with other MAC CEs e.g., BSR and/or PHR. In one example CSI information can be a single part. In one example, CSI information can include part 1 CSI and part 2 CSI. In one example, there are two UCI blocks or two MAC CE blocks or one UCI block and one MAC CE block, wherein the first UCI block or MAC CE is for HARQ-ACK and the second UCI block or MAC CE is for CSI (single part or two part CSI (part1 CSI+part 2 CSI)), in addition to a transport block for the UL-SCH with other MAC CEs. Each UCI block or MAC CE and transport block can be separately encoded and mapped to resource elements of PUSCH in the physical layer (hence different code rates).

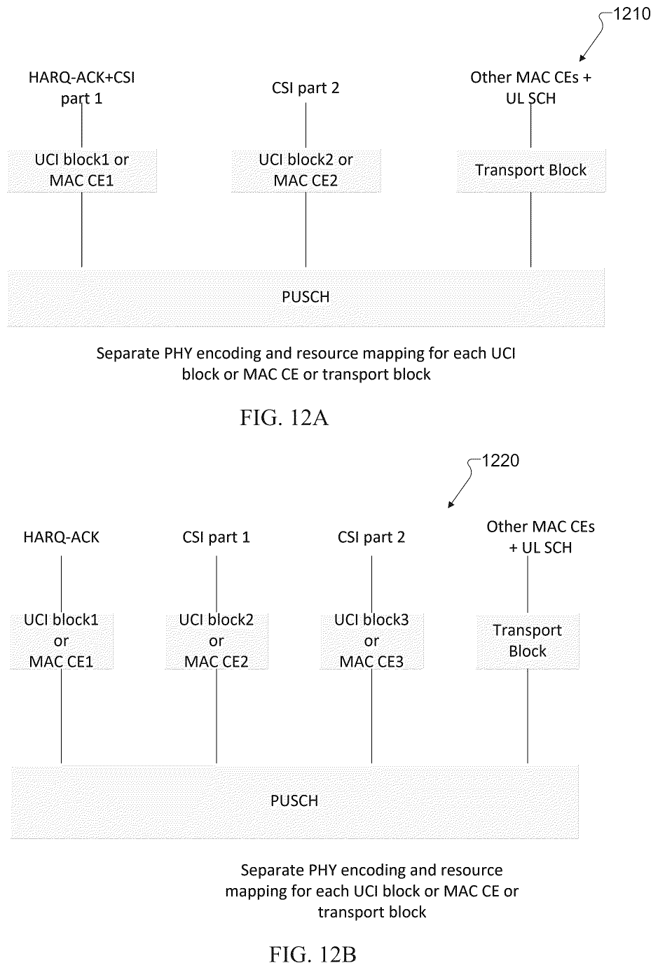

FIGS. 13A, 13B, and 13C illustrate an example UL transmission 1310, 1320, and 1330, respectively, according to embodiments of the present disclosure. For example, UL transmission 1310, 1320, and 1330, respectively, can be transmitted by any of the UEs 111-116 of FIG. 1, such as the UE 116. This example is for illustration only and other embodiments can be used without departing from the scope of the present disclosure.

In one example in FIG. 13A, UL transmission can include, (1) UL control information, wherein UL control information can include HARQ-ACK information and CSI information, and (2) UL-SCH with other MAC CEs e.g., BSR and/or PHR. CSI information can include part 1 CSI and part 2 CSI. In one example, there are two UCI blocks or two MAC CE blocks or one UCI block and one MAC CE block, wherein the first UCI block or MAC CE is for HARQ-ACK+part 1 CSI and the second UCI block or MAC CE is for part 2 CSI, in addition to a transport block for the UL-SCH with other MAC CEs. The UCI block(s) or MAC CE(s) are multiplexed together and can be jointly encoded and mapped to resource elements of PUSCH in the physical layer (hence same code rate for UCI). However, transport block can be separately encoded and mapped to resource elements of PUSCH in the physical layer (hence different code rates for UL-SCH and UCI).

In one example in FIG. 13B, UL transmission can include, (1) UL control information, wherein UL control information can include HARQ-ACK information and CSI information, and (2) UL-SCH with other MAC CEs e.g., BSR and/or PHR. CSI information can include part 1 CSI and part 2 CSI. In one example, there are three UCI blocks or a combination of three UCI blocks and MAC CE blocks, wherein the first UCI block or MAC CE is for HARQ-ACK and the second UCI block or MAC CE is for part 1 CSI and the third UCI block or MAC CE is for part 2 CSI, in addition to a transport block for the UL-SCH with other MAC CEs. The UCI block(s) or MAC CE(s) are multiplexed together and can be jointly encoded and mapped to resource elements of PUSCH in the physical layer (hence same code rate for UCI). However, transport block can be separately encoded and mapped to resource elements of PUSCH in the physical layer (hence different code rates for UL-SCH and UCI).

In one example in FIG. 13C, UL transmission can include, (1) UL control information, wherein UL control information can include HARQ-ACK information and CSI information, and (2) UL-SCH with other MAC CEs e.g., BSR and/or PHR. In one example CSI information can be a single part. In one example, CSI information can include part 1 CSI and part 2 CSI. In one example, there are two UCI blocks or two MAC CE blocks or one UCI block and one MAC CE block, wherein the first UCI block or MAC CE is for HARQ-ACK and the second UCI block or MAC CE is for CSI (single part or two part CSI (part1 CSI+part 2 CSI)), in addition to a transport block for the UL-SCH with other MAC CEs. The UCI block(s) or MAC CE(s) are multiplexed together and can be jointly encoded and mapped to resource elements of PUSCH in the physical layer (hence same code rate for UCI). However, transport block can be separately encoded and mapped to resource elements of PUSCH in the physical layer (hence different code rates for UL-SCH and UCI).

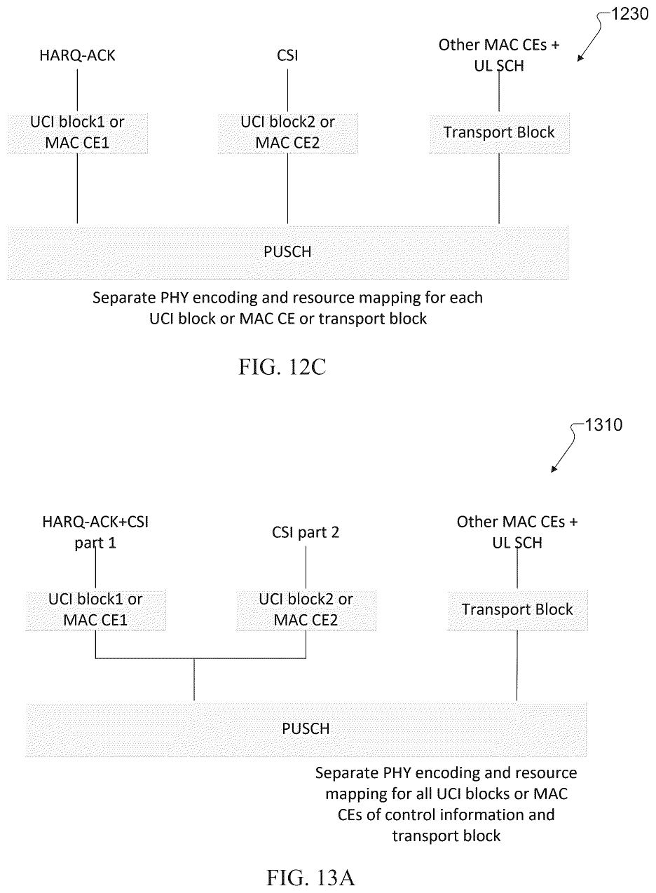

FIGS. 14A, 14B, and 14C illustrate an example UL transmission 1410, 1420, and 1430, respectively, according to embodiments of the present disclosure. For example, UL transmission 1410, 1420, and 1430, respectively, can be transmitted by any of the UEs 111-116 of FIG. 1, such as the UE 116. This example is for illustration only and other embodiments can be used without departing from the scope of the present disclosure.

In one example in FIG. 14A, UL transmission can include, (1) UL control information, wherein UL control information can include HARQ-ACK information and CSI information, and (2) UL-SCH with other MAC CEs e.g., BSR and/or PHR. CSI information can include part 1 CSI and part 2 CSI. In one example, there are two UCI blocks or two MAC CE blocks or one UCI block and one MAC CE block, wherein the first UCI block or MAC CE is for HARQ-ACK+part 1 CSI and the second UCI block or MAC CE is for part 2 CSI, in addition to a transport block for the UL-SCH with other MAC CEs. The UCI block(s) or MAC CE(s) and transport are multiplexed together and can be jointly encoded and mapped to resource elements of PUSCH in the physical layer (hence same code rate for UCI and UL-SCH).

In one example in FIG. 14B, UL transmission can include, (1) UL control information, wherein UL control information can include HARQ-ACK information and CSI information, and (2) UL-SCH with other MAC CEs e.g., BSR and/or PHR. CSI information can include part 1 CSI and part 2 CSI. In one example, there are three UCI blocks or three MAC CE blocks or a combination of three UCI blocks and MAC CE blocks, wherein the first UCI block or MAC CE is for HARQ-ACK and the second UCI block or MAC CE is for part 1 CSI and the third UCI block or MAC CE is for part 2 CSI, in addition to a transport block for the UL-SCH with other MAC CEs. The UCI block(s) or MAC CE(s) and transport are multiplexed together and can be jointly encoded and mapped to resource elements of PUSCH in the physical layer (hence same code rate for UCI and UL-SCH).

In one example in FIG. 14C, UL transmission can include, (1) UL control information, wherein UL control information can include HARQ-ACK information and CSI information, and (2) UL-SCH with other MAC CEs e.g., BSR and/or PHR. In one example CSI information can be a single part. In one example, CSI information can include part 1 CSI and part 2 CSI. In one example, there are two UCI blocks or two MAC CE blocks or one UCI block and one MAC CE block, wherein the first UCI block or MAC CE is for HARQ-ACK and the second UCI block or MAC CE is for CSI (single part or two part CSI (part1 CSI+part 2 CSI)), in addition to a transport block for the UL-SCH with other MAC CEs. The UCI block(s) or MAC CE(s) and transport are multiplexed together and can be jointly encoded and mapped to resource elements of PUSCH in the physical layer (hence same code rate for UCI and UL-SCH).

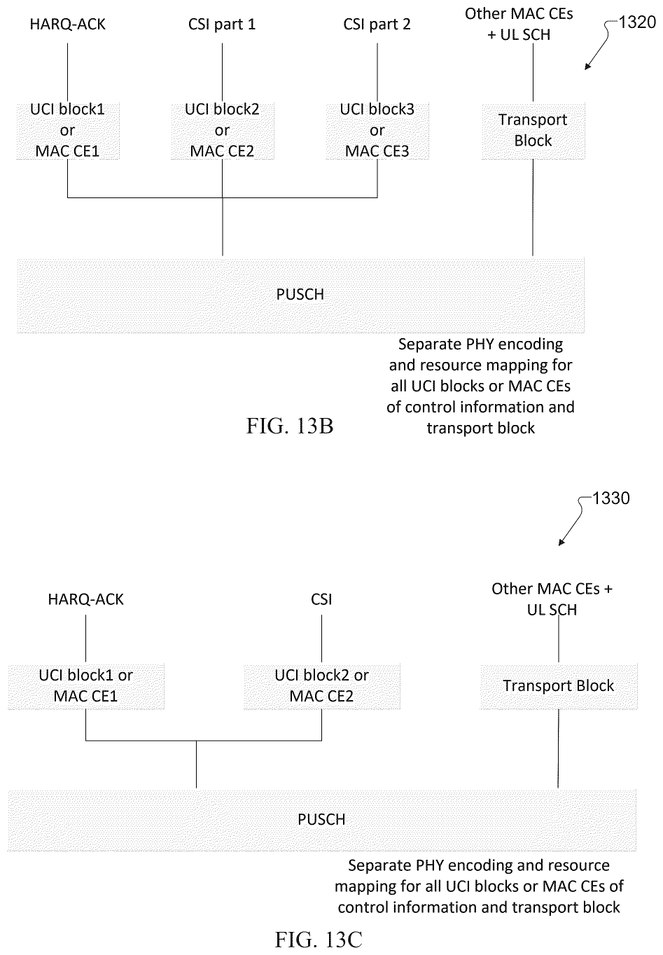

FIG. 15 illustrates an example UL transmission 1500 according to embodiments of the present disclosure. For example, UL transmission 1500 can be transmitted by the UE 116 of FIG. 3. This example is for illustration only and other embodiments can be used without departing from the scope of the present disclosure.

In one example in FIG. 15, UL transmission can include, (1) UL control information, wherein UL control information can include HARQ-ACK information and CSI information, and (2) UL-SCH with other MAC CEs e.g., BSR and/or PHR. In one example, CSI information can include part 1 CSI and part 2 CSI. In one example, CSI information can be a single part. In one example, there is one UCI block or one MAC CE block, wherein the UCI block or MAC CE is for HARQ-ACK+part 1 CSI+part 2 CSI or HARQ-ACK+CSI, in addition to a transport block for the UL-SCH with other MAC CEs. The UCI block or MAC CE and transport block can be separately encoded and mapped to resource elements of PUSCH in the physical layer (hence different code rate for UCI and UL-SCH).

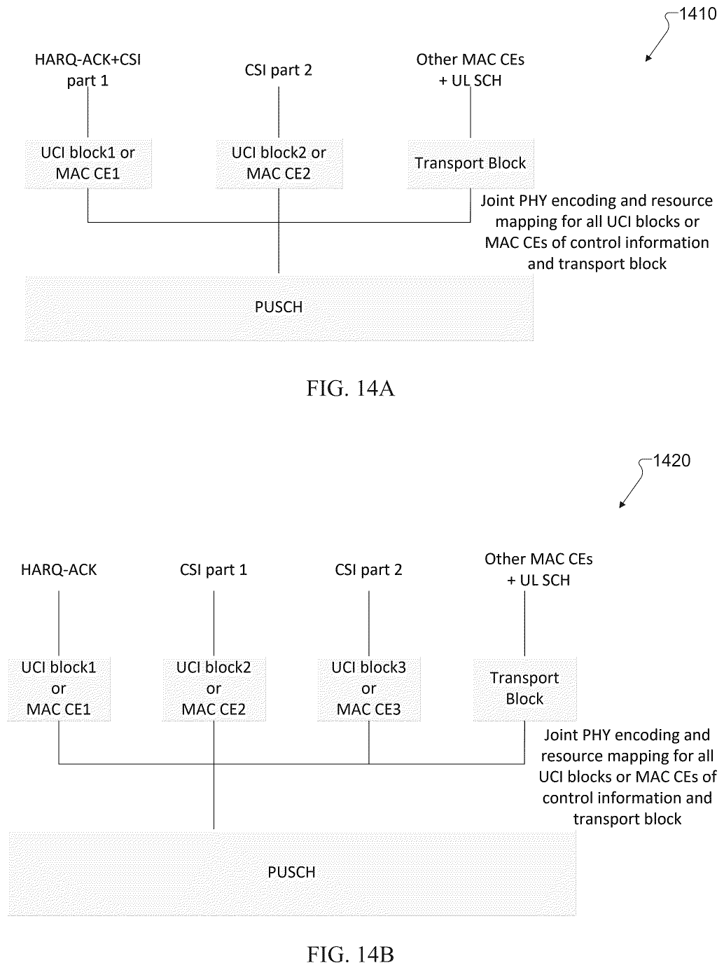

FIGS. 16A, 16B, and 16C illustrate an example UL transmission 1610, 1620, and 1630, respectively, according to embodiments of the present disclosure. For example, UL transmission 1610, 1620, and 1630, respectively, can be transmitted by any of the UEs 111-116 of FIG. 1, such as the UE 111. This example is for illustration only and other embodiments can be used without departing from the scope of the present disclosure.

In one example in FIG. 16A, UL transmission can include, (1) UL control information, wherein UL control information can include HARQ-ACK information and CSI information, and (2) UL-SCH with other MAC CEs e.g., BSR and/or PHR. CSI information can include part 1 CSI and part 2 CSI. In one example, there is one UCI block or one MAC CE block, wherein the UCI block or MAC CE is for HARQ-ACK+part 1 CSI, in addition to a part 2 CSI MAC CE and a transport block for the UL-SCH with other MAC CEs. The UCI block or MAC CE for HARQ-ACK/part 1 CSI and transport block with part 2 CSI MAC CE can be separately encoded and mapped to resource elements of PUSCH in the physical layer (hence different code rate for HARQ-ACK/part 1 CSI and UL-SCH/part 2 CSI).

In one example in FIG. 16B, UL transmission can include, (1) UL control information, wherein UL control information can include HARQ-ACK information and CSI information, and (2) UL-SCH with other MAC CEs e.g., BSR and/or PHR. CSI information can include part 1 CSI and part 2 CSI. In one example, there are two UCI blocks or two MAC CE blocks or one UCI block and one MAC CE block, wherein the first UCI block or MAC CE is for HARQ-ACK and the second UCI block or MAC CE is for CSI part 1, in addition to a part 2 CSI MAC CE and a transport block for the UL-SCH with other MAC CEs. The UCI blocks or MAC CEs for HARQ-ACK and part 1 CSI and transport block with part 2 CSI MAC CE can be separately encoded and mapped to resource elements of PUSCH in the physical layer (hence different code rate for HARQ-ACK/part 1 CSI and UL-SCH/part 2 CSI).

In one example in FIG. 16C, UL transmission can include, (1) UL control information, wherein UL control information can include HARQ-ACK information and CSI information, and (2) UL-SCH with other MAC CEs e.g., BSR and/or PHR. In one example CSI information can be a single part. In one example, CSI information can include part 1 CSI and part 2 CSI. In one example, there is one UCI block or one MAC CE block, wherein the UCI block or MAC CE is for HARQ-ACK, in addition to a CSI (single part or two part CSI (part1 CSI+part 2 CSI)) MAC CE and a transport block for the UL-SCH with other MAC CEs. The UCI block or MAC CE for HARQ-ACK and transport block with CSI MAC CE can be separately encoded and mapped to resource elements of PUSCH in the physical layer (hence different code rate for HARQ-ACK and UL-SCH/CSI).

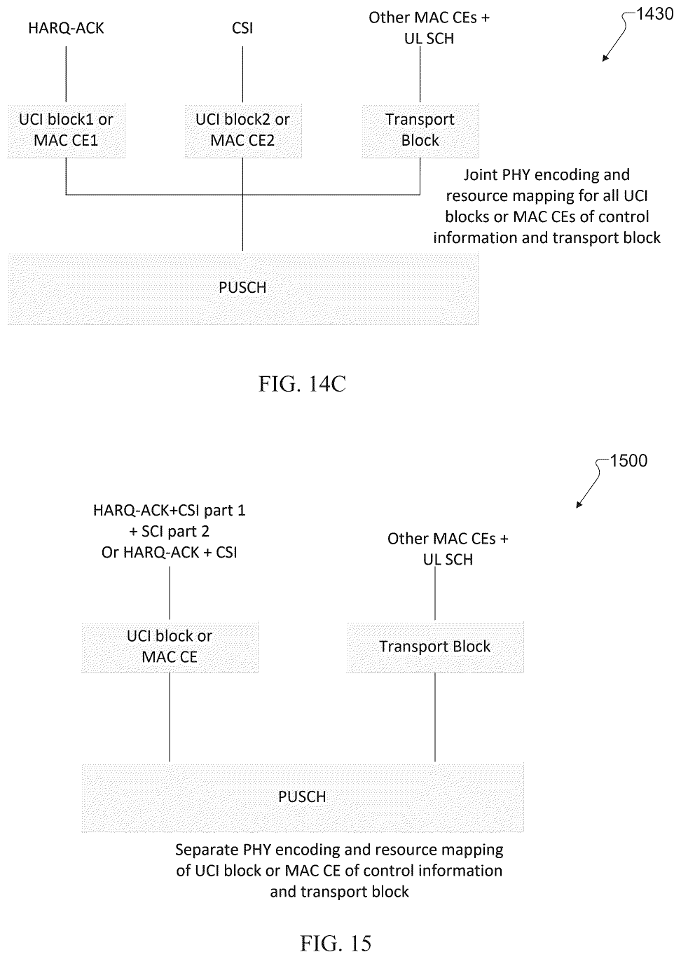

FIG. 17 illustrates an example UL transmission 1700 according to embodiments of the present disclosure. For example, UL transmission 1700 can be transmitted by any of the UEs 111-116 of FIG. 1, such as the UE 112. This example is for illustration only and other embodiments can be used without departing from the scope of the present disclosure.

In one example in FIG. 17, UL transmission can include, (1) UL control information, wherein UL control information can include HARQ-ACK information and CSI information, and (2) UL-SCH with other MAC CEs e.g., BSR and/or PHR. In one example, CSI information can include part 1 CSI and part 2 CSI. In one example, CSI information can be a single part. In one example, there is one transport block with MAC CE(s) for UCI, wherein the MAC CE(s) is for HARQ-ACK+part 1 CSI+part 2 CSI or HARQ-ACK+CSI, the transport block also includes UL-SCH with other MAC CEs. The transport block is encoded and mapped to resource elements of PUSCH in the physical layer (hence same code rate for UCI and UL-SCH).

In a variant of the examples mentioned herein, there can be one or more MAC CEs and/or one or more UCI blocks and/or one or more transport blocks each of which can be encoded and mapped to resource elements separately, hence transmitted with different transport characteristics.

In one example, if HARQ-ACK is 1 or 2 bits and multiplexed in PUSCH the following options can be evaluated:
Reserved resources in PUSCH (like NR)
Piggy-backed in other MAC CE as one or two bits
Separate MAC CE (this would be quite inefficient).

### Examples of Multiplexing

Periodic or aperiodic PUSCH or PUCCH carrying CSI, overlaps with PUCCH or PUSCH carrying HARQ-ACK is provided.

Multiplexing options:
CSI dropped, and HARQ-ACK transmitted on PUCCH or PUSCH
Separate transmission for PUSCH or PUCCH carrying CSI and PUSCH or PUCCH carrying HARQ-ACK, at least when the transmissions are on different cells.
HARQ-ACK multiplexed into PUSCH or PUCCH carrying CSI. Part of CSI may be dropped, e.g., if code rate can't be satisfied due to limited time frequency resources.
CSI multiplexed into PUSCH or PUCCH carrying HARQ-ACK. Part of CSI may be dropped, e.g., if code rate can't be satisfied due to limited time frequency resources.
HARQ-ACK and CSI are multiplexed in a PUCCH or a PUSCH.

SR request overlaps with PUSCH or PUCCH carrying CSI and/or PUCCH or PUSCH carrying HARQ-ACK is provided.

Multiplexing options include:
CSI dropped, and HARQ-ACK/SR transmitted on PUCCH or PUSCH
Separate transmission for PUSCH or PUCCH carrying CSI and PUSCH or PUCCH carrying HARQ-ACK/SR.
Separate transmission for PUSCH or PUCCH carrying CSI and PUSCH or PUCCH carrying HARQ-ACK and PUCCH with SR.
HARQ-ACK/SR multiplexed into PUSCH or PUCCH carrying CSI. Part of CSI may be dropped.
CSI/SR multiplexed into PUSCH or PUCCH carrying HARQ-ACK. Part of CSI may be dropped.

If CSI is only on PUSCH, then HARQ-ACK is multiplexed into PUSCH and SR is dropped (or SR is included if no UL-SCH). If a code rate for HARQ-ACK would exceed an RRC-configured code rate for HARQ-ACK, or a code rate for CSI would exceed an RRC-configured code rate for CSI, part of CSI can be dropped until the code rates mentioned herein become smaller than or equal to the corresponding configured code rates.

UL SCH overlaps with PUSCH or PUCCH carrying CSI and/or PUCCH or PUSCH carrying HARQ-ACK is provided.

Multiplexing options:
CSI dropped. HARQ-ACK and UL-SCH can be transmitted with or without multiplexing.
Separate transmission for PUSCH or PUCCH carrying CSI and PUSCH or PUCCH carrying HARQ-ACK and PUSCH with UL shared channels.
HARQ-ACK/CSI multiplexed into PUSCH carrying UL-SCH. Part of CSI may be dropped.

In one example, by having separate encoding for transport block, MAC CE(s) and UCI block(s), there can be different retransmission behavior. For example, if a first transmission has a first transport block and first MAC CE that are multiplexed onto the same physical channel, if the first transport block fails decoding, but the MAC CE decodes successfully, or the information in the MAC CE becomes stale and new information is available, the network (e.g., the network 130) can request the UE to re-transmit the first transport block with a new second MAC CE in the same physical channel. The receiver can apply HARQ combining to the transport block as it is separately included from the MAC CE.

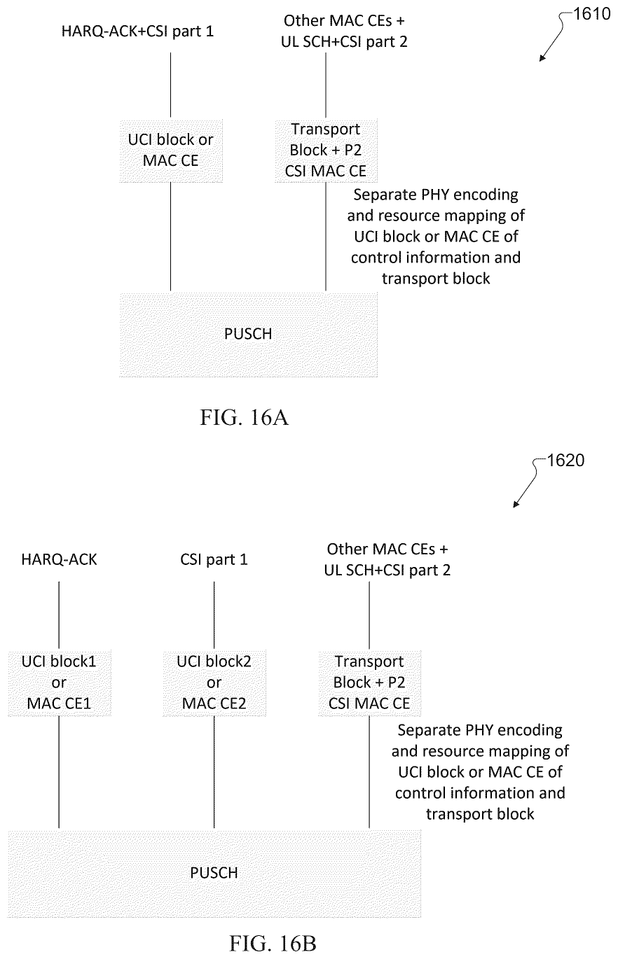

FIG. 18 illustrates example UL transmission resources 1800 according to embodiments of the present disclosure. For example, UL transmission resources 1800 can be utilized by any of the UEs 111-116 of FIG. 1, such as the UE 113. This example is for illustration only and other embodiments can be used without departing from the scope of the present disclosure.

In one example, a UE is configured with periodic CSI (P-CSI), or is activated with semi-persistent CSI (SP-CSI). In one example, P-CSI is transmitted on PUSCH resources or PUSCH-like resources. In one example, P-CSI is transmitted on PUCCH resources or PUCCH-like resources. In one example, SP-CSI is transmitted on PUSCH resources or PUSCH-like resources. In one example, SP-CSI is transmitted on PUCCH resources or PUCCH-like resources. In one example, an uplink transmission is dynamically indicated to the UE, and the uplink transmission overlaps (e.g., in time) with the resources of P-CSI or SP-CSI. In one example, the uplink transmission that is dynamically indicated is on PUSCH. In one example, the uplink transmission that is dynamically indicated is on PUCCH. In one example, UL transmission is for UL-SCH or aperiodic CSI indicated by a DCI Format (e.g., DCI Format 0-0 or DCI Format 0-1 or DCI Format 0-2 or DCI Format 0-3). In one example, UL transmission is for HARQ-ACK feedback indicated by a DCI Format (e.g., DCI Format 1-0 or DCI Format 1-1 or DCI Format 1-2 or DCI Format 1-3). In one example, when overlap in time of the dynamic uplink transmission and periodic or semi-persistent resources occur, the UE uses the resources of the dynamic uplink transmission as illustrated in FIG. 18. In one example, the P-CSI or the SP-CSI that overlaps the dynamic UL transmission is dropped. In one example, the P-CSI or the SP-CSI that overlaps the dynamic UL transmission is multiplexed into the dynamic UL transmission. In one example, the DCI format scheduling or allocating resources for the dynamic UL transmission indicates (e.g., by a flag or a field in the DCI format) whether or not to multiplex the P-CSI or the SP-CSI with the dynamic uplink transmission as indicated in FIG. 18. In FIG. 18, the instances of P-CSI (e.g., on PUSCH) or SP-CSI that don't overlap a dynamically scheduled UL transmission are transmitted. The instances of P-CSI (e.g., on PUSCH) or SP-CSI that overlap a dynamically scheduled UL transmission are dropped. In one example, if P-CSI or SP-CSI is multiplexed on the dynamic UL transmission, the network allocates sufficient resources for the multiplexing to occur.

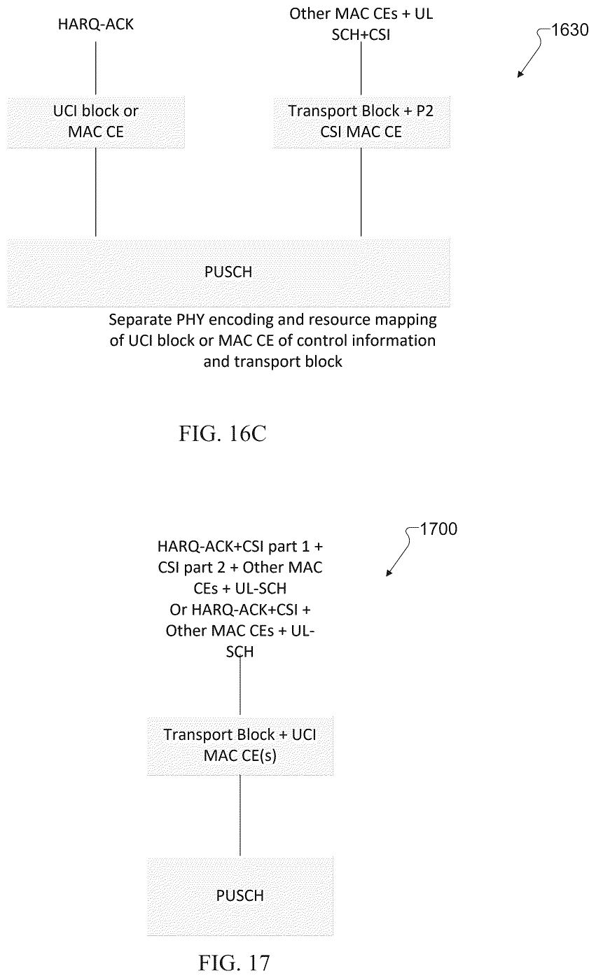

FIG. 19 illustrates example UL transmission resources 1900 according to embodiments of the present disclosure. For example, UL transmission resources 1900 can be utilized by any of the UEs 111-116 of FIG. 1, such as the UE 114. This example is for illustration only and other embodiments can be used without departing from the scope of the present disclosure.

In one example, a UE is configured with configured grant PUSCH (CG-PUSCH) Type 1, or is activated configured grant PUSCH (CG-PUSCH) Type 2. In one example, an uplink transmission is dynamically indicated to the UE, and the uplink transmission overlaps (e.g., in time) with the resources CG-PUSCH (Type 1 or Type 2). In one example, the uplink transmission that is dynamically indicated is on PUSCH. In one example, the uplink transmission that is dynamically indicated is on PUCCH. In one example, UL transmission is for UL-SCH or aperiodic CSI indicated by a DCI Format (e.g., DCI Format 0-0 or DCI Format 0-1 or DCI Format 0-2 or DCI Format 0-3). In one example, UL transmission is for HARQ-ACK feedback indicated by a DCI Format (e.g., DCI Format 1-0 or DCI Format 1-1 or DCI Format 1-2 or DCI Format 1-3). In one example, when overlapping in time of the dynamic uplink transmission and CG-PUSCH (e.g., Type 1 or Type 2) occur, the UE uses the resources of the dynamic uplink transmission as illustrated in FIG. 19. In one example, the CG-PUSCH (e.g., Type 1 or Type 2) that overlaps the dynamic UL transmission is dropped. In FIG. 19, the instances of CG-PUSCH (e.g., Type 1 or Type 2) that don't overlap a dynamically scheduled UL transmission are transmitted. The instances of CG-PUSCH (e.g., Type 1 or Type 2) that overlap a dynamically scheduled UL transmission are dropped.

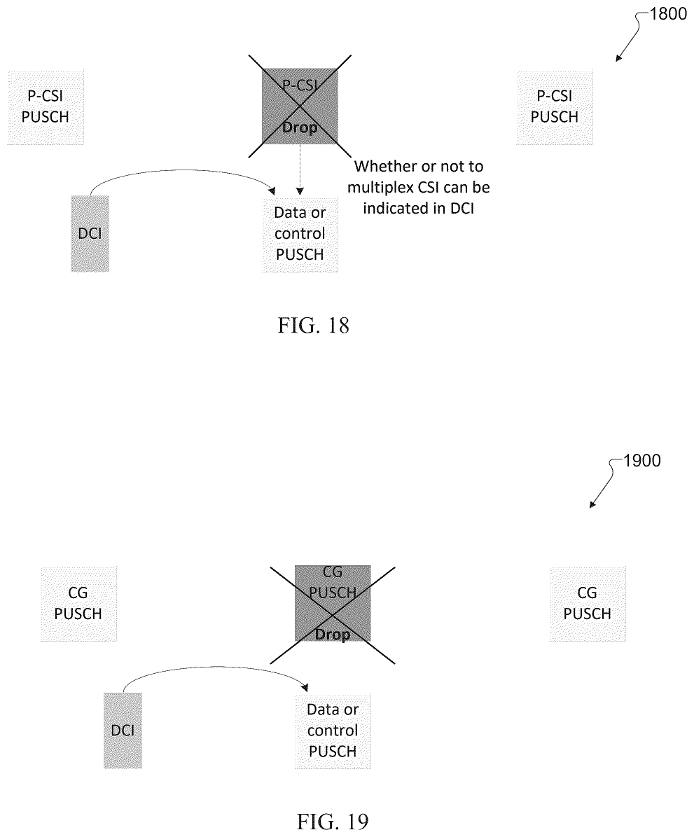

FIG. 20 illustrates example UL transmission resources 2000 according to embodiments of the present disclosure. For example, UL transmission resources 2000 can be utilized by any of the UEs 111-116 of FIG. 1, such as the UE 115. This example is for illustration only and other embodiments can be used without departing from the scope of the present disclosure.

In one example, a UE is indicated (e.g., by dynamic signaling—dynamic signaling can be L1 control e.g., DCI or MAC CE) a first UL transmission on a first resources, a UE is indicated (e.g., by dynamic signaling) a second UL transmission on a second resources, wherein the first resource and the second resource at least overlap in time. The UE is indicated the first UL transmission at time T₁ and is indicated the second UL transmission at time T₂, where T₁ and T₂ can be the start time of the corresponding dynamic signaling (e.g., DCI Format or MAC CE), or the end time of the corresponding dynamic signaling. T₁<T₂, i.e., the first UL transmission is indicated before the second UL transmission as illustrated in FIG. 20. In one example, the first UL transmission is transmitted on PUSCH resources or PUSCH-like resources. In one example, the first UL transmission is transmitted on PUCCH resources or PUCCH-like resources. In one example, the second UL transmission is transmitted on PUSCH resources or PUSCH-like resources. In one example, the second UL transmission is transmitted on PUCCH resources or PUCCH-like resources.

In one example, the first UL transmission is for UL-SCH or aperiodic CSI and is indicated by a DCI Format (e.g., DCI Format 0-0 or DCI Format 0-1 or DCI Format 0-2 or DCI Format 0-3). In one example, first UL transmission is for HARQ-ACK feedback and is indicated by a DCI Format (e.g., DCI Format 1-0 or DCI Format 1-1 or DCI Format 1-2 or DCI Format 1-3). In one example, the second UL transmission is for UL-SCH or aperiodic CSI and is indicated by a DCI Format (e.g., DCI Format 0-0 or DCI Format 0-1 or DCI Format 0-2 or DCI Format 0-3). In one example, second UL transmission is for HARQ-ACK feedback and is indicated by a DCI Format (e.g., DCI Format 1-0 or DCI Format 1-1 or DCI Format 1-2 or DCI Format 1-3).

In one example, the UE (e.g., the UE 116) drops the first UL transmission and transmits the second UL transmission, e.g., as illustrated in FIG. 20. In one example, the UE drops the information of the first UL transmission. In one example, the UE multiplexes the information of the first UL transmission into the second UL transmission. In one example, the DCI format scheduling or allocating resources for the second UL transmission indicates (e.g., by a flag or a field in the DCI format) whether or not to multiplex the information of the first (or an earlier indicated) UL transmission with the second uplink transmission. In one example, the DCI format scheduling or allocating resources for the first UL transmission indicates (e.g., by a flag or a field in the DCI format) whether or not to multiplex the information of the first transmission with the second (or a later overlapping) uplink transmission. In one example, if information of first UL transmission is multiplexed on the second UL transmission, the network allocates sufficient resources for the multiplexing to occur.

In a variant example of FIG. 20, whether to multiplex the information of the first UL transmission into the second UL transmission can depend on the priorities of the first and second UL transmissions. In one example, if the priority of the second UL transmission is higher than the priority of the first UL transmission, the information of the first UL transmission is dropped and the second UL transmission is transmitted. In one example, if the priority of the second UL transmission high, the information of the first UL transmission is dropped and the second UL transmission is transmitted. In one example, if the priority of the second UL transmission is equal to the priority of the first UL transmission, the information of the first UL transmission is multiplexed into the second UL transmission. In one example, if the priority of the first UL transmission is higher than the priority of the second UL transmission, the information of the second UL transmission is dropped and the first UL transmission is transmitted. In one example, if the priority of the first UL transmission high, the information of the second UL transmission is dropped and the first UL transmission is transmitted.

In one example, if a first UL transmission is associated with, or scheduled by or allocated by an UL-related (e.g., for UL grant) DCI Format (e.g., DCI Format 0-0 or DCI Format 0-1 or DCI Format 0-2 or DCI Format 0-3), and if a second UL transmission is associated with, or scheduled by or allocated by a non-UL-related or by a DL-related (e.g. for DL assignment) DCI Format (e.g., DCI Format 1-0 or DCI Format 1-1 or DCI Format 1-2 or DCI Format 1-3), and the first UL transmission and the second UL transmission overlap (e.g., in time), the information associated with the second UL transmission is multiplexed in the first UL transmission. In one example, whether to multiplex or not can be indicated by a field or flag in the DCI format associated with the first uplink transmission. In one example, whether to multiplex or not can be indicated by a field or flag in the DCI format associated with the second uplink transmission. In one example, if is no multiplexing (e.g., based on field or flag), the first UL transmission is dropped. In one example, if is no multiplexing (e.g., based on field or flag), the second UL transmission is dropped. In one example, if is no multiplexing (e.g., based on field or flag), the first UL transmission and the second UL transmission are transmitted in parallel.

In one example, if a first uplink transmission with a small payload, and uses an uplink transmission format with multiplexing capability on the same resource (e.g., PUCCH Format 0 like or PUCCH Format 1 like or PUCCH Format 4 like) overlaps (e.g., in time) with a second uplink transmission with a large payload and uses an uplink transmission structure similar to PUSCH, the following examples can be evaluated:
The first UL transmission and the second UL transmission are transmitted in parallel. In one example, a UE capability can indicated whether the UE supports parallel transmission or not. In one example, the UE can be configured whether or not to have parallel transmissions, when overlapping (e.g., in time) UL transmission occur.
The information of the first UL transmission is multiplexed into the second UL transmission.
The first UL transmission is dropped and the second UL transmission is transmitted.
The second UL transmission is dropped and the first UL transmission is transmitted.
The transmission with a higher priority is transmitted and the other transmission is dropped.
If the second transmission has a lower priority than the first transmission, the second transmission is transmitted, and the information associated with the first transmission is multiplexed into the second transmission.
If the second transmission has equal priority to the first transmission, the second transmission is transmitted, and the information associated with the first transmission is multiplexed into the second transmission

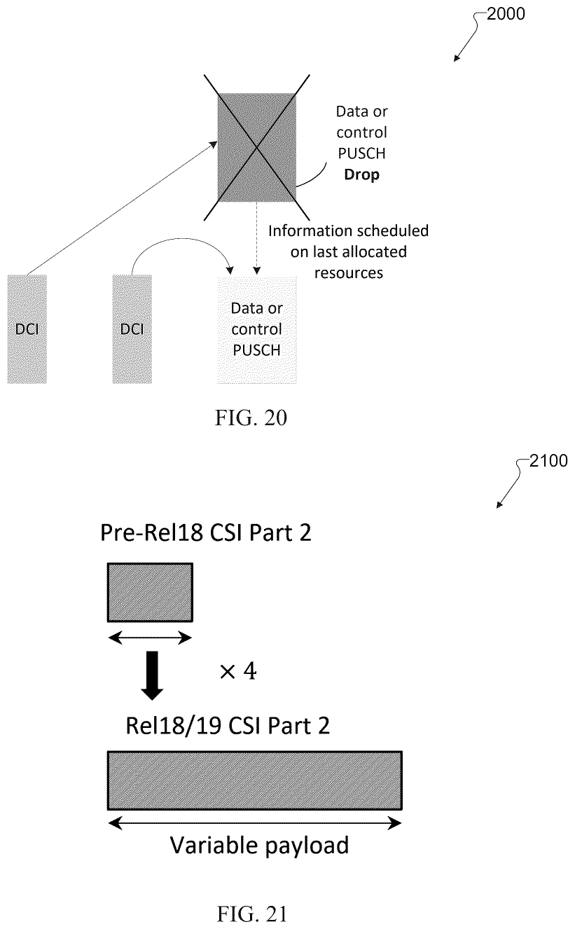

FIG. 21 illustrates an example CSI 2100 according to embodiments of the present disclosure. For example, CSI 2100 can be measured by the UE 116 of FIG. 3. This example is for illustration only and other embodiments can be used without departing from the scope of the present disclosure.

In one example, 5G NR UCI Rate Matching on PUSCH is used for a framework for rate matching in 6G or beyond wireless communication and it is provided as follows.

UCI+Data on PUSCH:
Beta offsets for HARQ-ACK, CSI Part 1, and CSI Part 2
   They are control parameters to determine a number of REs for multiplexing HARQ-ACK/CSI in a PUSCH→effectively control code rate for each UCI part
   It can be signaled/configured via RRC or DCI signaling
Alpha value for UCI (RRC only)
   It is a scaling factor to limit the number of REs assigned to UCI (including HARQ/CSI) on PUSCH

UCI only on PUSCH
Beta offsets for HARQ-ACK and CSI Part 1
   Same as herein, but beta offset for CSI Part 2 is not used, since remaining REs will be assigned for CSI Part 2

In one example, a number of coded modulation symbols per layer is provided for HARQ-ACK, CSI Part 1, and CSI Part 2 (=a number of REs required for the coded bits) as follows.

$${Q}_{A C K}^{′} = min \{ ⌈ \frac{( {O}_{A C K} + {L}_{A C K} ) \cdot {β}_{offset}^{HARQ - A C K} \cdot {\sum }_{l = 0}^{{N}_{symb , {all}^{- 1}}^{PUSCH}} {M}_{S C}^{UCI} ( l )}{{\sum }_{r = 0}^{{C}_{UL - {SCH}^{- 1}}} {K}_{r}} ⌉ , ⌈ α \cdot {\sum }_{l = {l}_{0}}^{{N}_{symb , {all}^{- 1}}^{PUSCH}} {M}_{S C}^{UCI} ( l ) ⌉ \}$$

$${Q}_{CSI - 1}^{′} = min \{ ⌈ \frac{( {O}_{CSI - 1} + {L}_{CSI - 1} ) \cdot {β}_{offset}^{CSI - part 1} \cdot {\sum }_{l = 0}^{{N}_{symb , {all}^{- 1}}^{PUSCH}} {M}_{S C}^{UCI} ( l )}{{\sum }_{r = 0}^{{C}_{UL - {SCH}^{- 1}}} {K}_{r}} ⌉ , ⌈ α \cdot {\sum }_{l = 0}^{{N}_{symb , {all}^{- 1}}^{PUSCH}} {M}_{S C}^{UCI} ( l ) ⌉ - {Q}_{ACK / CG - UCI}^{′} \}$$

$${Q}_{C S I - 2}^{′} = min \{ ⌈ \frac{( {O}_{C S I - 2} + {L}_{C S I - 2} ) \cdot {β}_{offset}^{CSI - part 2} \cdot {\sum }_{l = 0}^{{N}_{symb , {all}^{- 1}}^{PUSCH}} {M}_{S C}^{UCI} ( l )}{{\sum }_{r = 0}^{{C}_{UL - {SCH}^{- 1}}} {K}_{r}} ⌉ , ⌈ α \cdot {\sum }_{l = 0}^{{N}_{symb , {all}^{- 1}}^{PUSCH}} {M}_{S C}^{UCI} ( l ) ⌉ - {Q}_{ACK / CG - UCI}^{′} - {Q}_{CSI - 1}^{′} \}$$

where (details included in 6.3.2.4.1 of [REF 2])
O: number of information bits
L: number of cyclic redundancy check (CRC) bits

$$\frac{{\sum }_{l = 0}^{{N}_{symb , {all}^{- 1}}^{PUSCH}} {M}_{S C}^{UCI} ( l )}{{\sum }_{r = 0}^{{C}_{UL - {SCH}^{- 1}}} {K}_{r}} :$$

number of REs per coded bit

$$α \cdot {\sum }_{l}^{{N}_{symb , {all}^{- 1}}^{PUSCH}} {M}_{S C}^{UCI} ( l ) :$$

a maximum number of REs allocated to UCI on PUSCH
α: RRC parameter configured by scaling (0.5, 0.65, 0.8, or 1)
β: beta offset
   Range for HARQ-ACK: [0.05, 126]
   Range for CSI Part 1/2: [1.125, 20]

In one example, effective code rate of UCI on PUSCH is determined by beta offset

In one example, alpha value and beta offsets determine numbers of REs required for UCI of HARQ-ACK, CSI Part 1, and CSI Part 2.

In one example, relevant RRC parameters for Beta Offsets and alpha value are provided.

```
In PUSCH-Config:
UCI-OnPUSCH ::= SEQUENCE
  betaOffsets
    CHOICE
```

| | |
|---|---|
| dynamic | SEQUENCE (SIZE (4)) OF BetaOffsets, |
| semiStatic | BetaOffsets |
| } | OPTIONAL, -- Need M |
| scaling | ENUMERATED { f0p5, f0p65, f0p8, f1 } } |

```
}
-- ASN1START
-- TAG-BETAOFFSETS-START
BetaOffsets ::= SEQUENCE {
  betaOffsetACK-Index1 INTEGER (0..31) OPTIONAL, -- Need S
  betaOffsetACK-Index2 INTEGER (0..31) OPTIONAL, -- Need S
  betaOffsetACK-Index3 INTEGER (0..31) OPTIONAL, -- Need S
  betaOffsetCSI-Part1-Index1 INTEGER (0..31) OPTIONAL, -- Need S
  betaOffsetCSI-Part1-Index2 INTEGER (0..31) OPTIONAL, -- Need S
  betaOffsetCSI-Part2-Index1 INTEGER (0..31) OPTIONAL, -- Need S
  betaOffsetCSI-Part2-Index2 INTEGER (0..31) OPTIONAL -- Need S
}
-- TAG-BETAOFFSETS-STOP
-- ASN1STOP
```

In 5G NR, CSI Part 2 payload size is largely variable, depending on the signaled info in CSI Part 1, for example, Rel-18 coherent joint transmission (CJT) Type-II CSI due to Dynamic TRP selection.

In one example, depending on the TRP selection signaled in Part 1, CSI Part 2 payload size can be varying around from 600 bits to 2500 bits.
Furthermore, there is a tendency that the range of variable CSI Part 2 size becomes larger, as NR evolves, e.g., Rel-19 Type-II CSI with 128 ports, Rel-19 CSI-RS resource indicator (CRI)-based Type-I/II CSI, Rel-18 CJT Type-II CSI.

Hence, it may be difficult to efficiently allocate resource allocation for UCI.

If UL resources for UCI is too tightly allocated, UCI omission can happen with a higher probability.

If UL resources for UCI is loosely allocated (i.e., to contain max payload of Part 2), UL RA for UCI is inefficient.

In one example, CSI Part 1 includes (or indicates) an updated beta offset and/or alpha value for CSI Part 2.
In one example, depending on the payload size of CSI Part 2 determined by the info in CSI Part 1, UE updates alpha value or beta offset to adjust effective code rate and includes it in the CSI Part 1.
   If payload size is large (exceeding the limit the current beta offset and alpha value supports), UE indicates smaller value of beta offset and/or larger value of alpha value in CSI Part 1 allows to reduce the #of REs for CSI Part 2.

In one example, two-(or multi-)stage UL resource allocation for UCI is provided. In one example, a set of resources for UCI is configured for a first stage of uplink resource allocation (ULRA). In most of cases, the first stage of ULRA would be sufficient for UE to send/report UCI. However, in one example, in case that additional ULRA is needed, the UE may request/indicate that additional (optional) ULRA for the UCI is to be used or needed. This can be done, in one example, a 2^{nd} stage UL RA configuration, where the 2^{nd} UL RA configuration can be signaled via RRC signaling (or MAC-CE or DCI).

In one example, the UE can indicate whether the 2^{nd} UL RA configuration is to be used or not. For example, the UE includes an indicator in CSI Part 1 to enable/indicate the 2^{nd} stage UL RA for CSI Part 2. In another example, the UE includes an indicator in CSI Part 1 to indicate/select a subset of the resources configured in the 2^{nd} stage UL RA.

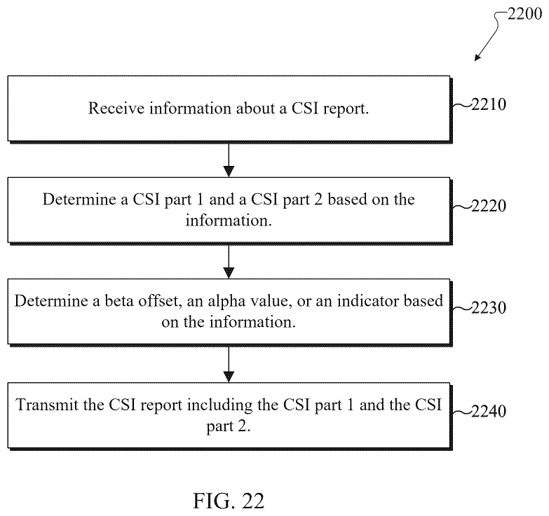

FIG. 22 illustrates an example method 2200 performed by a UE in a wireless communication system according to embodiments of the present disclosure. The method 2200 of FIG. 22 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 2200 is for illustration only and other embodiments can be used without departing from the scope of the present disclosure.

The method 2200 begins with the UE receiving information about a CSI report (2210). The UE then determines a CSI part 1 and a CSI part 2 based on the information (2220).

The UE then determines a beta offset, an alpha value, or an indicator based on the information (2230). For example, in 2230, the beta offset is a parameter to control a code rate for the CSI part 2, the alpha value is a scaling factor to limit a number of UL REs for the CSI part 2, and the indicator indicates information related to an additional UL RA for the CSI part 2.

In various embodiments, the beta offset β is indicated by a differential indicator with respect to a second beta offset β̅, where the second beta offset β̅ is configured via RRC signaling or DCI signaling. An alphabet set for the differential indicator includes 1 and β=cβ̅, where c is a value indicated by the differential indicator.

In various embodiments, the alpha value α is indicated by a differential indicator with respect to a second alpha value α̅, where the second alpha value α̅ is configured via RRC signaling or DCI signaling. An alphabet set for the differential indicator includes 1 and α=dα̅, where d is a value indicated by the differential indicator.

In various embodiments, the indicator is a 1-bit indicator to indicate whether the additional UL RA is to be used for the CSI Part 2. In various embodiments, the indicator is configured via RRC signaling or DCI signaling.

The UE then transmits the CSI report including the CSI part 1 and the CSI part 2 (2240). For example, in 2240, the CSI part 1 includes at least one of the beta offset, the alpha value, and the indicator.

Any of the above variation embodiments can be utilized independently or in combination with at least one other variation embodiment.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) comprising:
a transceiver configured to receive information about a channel state information (CSI) report; and
a processor operably coupled to the transceiver, the processor configured to determine, based on the information:
a CSI part 1 and a CSI part 2, and
a beta offset, an alpha value, or an indicator, wherein:
the beta offset is a parameter to control a code rate for the CSI part 2,
the alpha value is a scaling factor to limit a number of uplink (UL) resource elements (REs) for the CSI part 2, and
the indicator indicates information related to an additional UL resource allocation (UL RA) for the CSI part 2,
wherein the transceiver is further configured to transmit the CSI report including the CSI part 1 and the CSI part 2, and
wherein the CSI part 1 includes at least one of the beta offset, the alpha value, and the indicator.

2. The UE of claim 1, wherein the beta offset β is indicated by a differential indicator with respect to a second beta offset β̅, where the second beta offset β̅ is configured via radio resource control (RRC) signaling or downlink control information (DCI) signaling.

3. The UE of claim 2, wherein an alphabet set for the differential indicator includes 1 and β=cβ̅, where c is a value indicated by the differential indicator.

4. The UE of claim 1, wherein the alpha value α is indicated by a differential indicator with respect to a second alpha value α̅, where the second alpha value α̅ is configured via radio resource control (RRC) signaling or downlink control information (DCI) signaling.

5. The UE of claim 4, wherein an alphabet set for the differential indicator includes 1 and α=dα̅, where d is a value indicated by the differential indicator.

6. The UE of claim 1, wherein the indicator is a 1-bit indicator to indicate whether the additional UL RA is to be used for the CSI Part 2.

7. The UE of claim 1, wherein the indicator is configured via radio resource control (RRC) signaling or downlink control information (DCI) signaling.

8. A base station (BS) comprising:
a processor; and
a transceiver operably coupled to the processor, the transceiver configured to:
transmit information about a channel state information (CSI) report; and
receive the CSI report including a CSI part 1 and a CSI part 2, wherein:
the CSI part 1 includes at least one of a beta offset, an alpha value, and an indicator,
the beta offset is a parameter to control a code rate for the CSI part 2,
the alpha value is a scaling factor to limit a number of uplink (UL) resource elements (REs) for the CSI part 2, and
the indicator indicates information related to an additional UL resource allocation (UL RA) for the CSI part 2.

9. The BS of claim 8, wherein the beta offset β is indicated by a differential indicator with respect to a second beta offset β̅, where the second beta offset β̅ is configured via radio resource control (RRC) signaling or downlink control information (DCI) signaling.

10. The BS of claim 9, wherein an alphabet set for the differential indicator includes 1 and β=cβ̅, where c is a value indicated by the differential indicator.

11. The BS of claim 8, wherein the alpha value α is indicated by a differential indicator with respect to a second alpha value α̅, where the second alpha value α̅ is configured via radio resource control (RRC) signaling or downlink control information (DCI) signaling.

12. The BS of claim 11, wherein an alphabet set for the differential indicator includes 1 and α=dα̅, where d is a value indicated by the differential indicator.

13. The BS of claim 8, wherein the indicator is a 1-bit indicator to indicate whether the additional UL RA is to be used for the CSI Part 2.

14. The BS of claim 8, wherein the indicator is configured via radio resource control (RRC) signaling or downlink control information (DCI) signaling.

15. A method performed by a user equipment (UE), the method comprising:
receiving information about a channel state information (CSI) report;
determining, based on the information:
a CSI part 1 and a CSI part 2, and
a beta offset, an alpha value, or an indicator, wherein:
the beta offset is a parameter to control a code rate for the CSI part 2,
the alpha value is a scaling factor to limit a number of uplink (UL) resource elements (REs) for the CSI part 2, and
the indicator indicates information related to an additional UL resource allocation (UL RA) for the CSI part 2; and
transmitting the CSI report including the CSI part 1 and the CSI part 2, wherein the CSI part 1 includes at least one of the beta offset, the alpha value, and the indicator.

16. The method of claim 15, wherein the beta offset β is indicated by a differential indicator with respect to a second beta offset β̅, where the second beta offset β̅ is configured via radio resource control (RRC) signaling or downlink control information (DCI) signaling.

17. The method of claim 16, wherein an alphabet set for the differential indicator includes 1 and β=cβ̅, where c is a value indicated by the differential indicator.

18. The method of claim 15, wherein the alpha value α is indicated by a differential indicator with respect to a second alpha value α̅, where the second alpha value α̅ is configured via radio resource control (RRC) signaling or downlink control information (DCI) signaling.

19. The method of claim 18, wherein an alphabet set for the differential indicator includes 1 and α=dα̅, where d is a value indicated by the differential indicator.

20. The method of claim 15, wherein the indicator is a 1-bit indicator to indicate whether the additional UL RA is to be used for the CSI Part 2.
